(19) United States
(12) Patent Application Publication
(10) Pub. No.: US 2026/0321047 A1
(43) Pub. Date: Oct. 15, 2026

(54) UTILIZING MULTIMODAL LARGE LANGUAGE MODELS TO IDENTIFY GROUNDING TEXT CONTENT WITHIN DIGITAL IMAGES

(71) Applicant: Adobe Inc., San Jose, CA (US)

(72) Inventors: Ruiyi Zhang, San Jose, CA (US); Yufan Zhou, Buffalo, NY (US); Wanrong Zhu, Seattle, WA (US); Tong Sun, San Jose, CA (US); Ryan A. Rossi, Santa Clara, CA (US); Nedim Lipka, Santa Clara, CA (US); Jiuxiang Gu, College Park, MD (US); Ming Li, Greenbelt, MD (US); Franck Dernoncourt, Seattle, WA (US)

(21) Appl. No.: 19/174,591

(22) Filed: Apr. 9, 2025

(51) Int. Cl. G06V 30/148; G06F 40/284; G06F 40/40; G06T 7/70; G06V 30/19

(52) U.S. Cl. CPC G06V 30/153; G06F 40/284; G06F 40/40; G06T 7/70; G06V 30/19093; G06V 30/19147; G06V 30/1916

(57) ABSTRACT

The present disclosure is directed toward systems, methods, and non-transitory computer readable media that train, utilize, and/or evaluate multimodal large language models in visual text grounding including identifying grounding text content within digital images that supports text answers to text questions. For example, the disclosed systems receive a text question associated with a digital image that includes text content. Furthermore, the disclosed systems generate a large language model prompt which includes the digital image, the text question, and an instruction to generate a text answer and identify a portion of the text content of the digital image that supports the text answer. The disclosed systems utilize the large language model prompt to prompt a multimodal large language model to generate a text answer to the text question from the text content of the digital image and generate a text description that identifies grounding text content supporting the text answer.

### BACKGROUND

Advancements in computing devices and digital content systems have led to increases in the use and capabilities of digital content systems that process digital images. For example, many digital content systems perform a wide array of workflows on digital images, including the display, modification, and analysis of digital images across diverse applications. A key aspect of many digital image workflows includes working with multimodal digital images that integrate multiple content types, such as structured documents, graphical data representations, and hierarchical visual elements. However, the variability of digital image content introduces significant challenges in performing visual analysis on digital images. For example, many digital content analysis systems struggle to identify relevant grounding text content within a digital image that supports text answers to text questions. As such, existing visual image analysis systems face limitations in accuracy, computational efficiency, and efficacy when identifying grounding text content within digital images that supports text answers to text questions.

### SUMMARY

One or more embodiments provide benefits and/or solve one or more of the foregoing or other problems in the art with systems, methods, and non-transitory computer readable storage media that train, utilize, and/or evaluate multimodal large language models in visual text grounding including identifying grounding text content within digital images that supports text answers to text questions. For example, the disclosed systems receive a text question associated with a digital image that includes text content. In some cases, the disclosed systems generate a large language model prompt which includes the digital image, the text question, and an instruction to generate a text answer for the text question and identify a portion of the text content of the digital image that supports the text answer for the text question (e.g., identify grounding text content and/or grounding shape(s)). Utilizing the large language model prompt, certain embodiments of the disclosed systems prompt a multimodal large language model to generate a text answer to the text question from the text content of the digital image and generate a text description that identifies grounding text content supporting the text answer.

### BRIEF DESCRIPTION OF THE DRAWINGS

This disclosure will describe one or more example embodiments of the systems and methods with additional specificity and detail by referencing the accompanying figures. The following paragraphs briefly describe those figures, in which:

FIG. 1 illustrates a schematic diagram of an example environment of a visual text grounding system in accordance with one or more embodiments;

FIG. 2A illustrates an example overview of the visual text grounding system 106 generating a text answer for a text question and identifying supportive grounding shapes based on text content of a digital image in accordance with one or more embodiments;

FIG. 2B illustrates an example of the visual text grounding system generating a machine learning model dataset for training or evaluating multimodal large language models in accordance with one or more embodiments;

FIG. 3 illustrates an example of the visual text grounding system utilizing an instruction-based method to generate a text answer and a text description in accordance with one or more embodiments;

FIG. 4 illustrates an example of the visual text grounding system utilizing an instruction-based training method to train a multimodal large language model to generate a text answer and text description in accordance with one or more embodiments;

FIG. 5 illustrates an example of the visual text grounding system utilizing an embedding-based method to identify grounding text in accordance with one or more embodiments;

FIG. 6 illustrates an example of the visual text grounding system utilizing an embedding-based training method to train multimodal large language models to generate embeddings to identify grounding text content in accordance with one or more embodiments;

FIGS. 7A-7C illustrate an example of the visual text grounding system utilizing a dataset generation model to generate a machine learning model dataset in accordance with one or more embodiments;

FIG. 8 illustrates an example of the visual text grounding system utilizing a machine learning model dataset to evaluate the OCR-free visual text grounding capability of multimodal large language models in accordance with one or more embodiments;

FIG. 9 illustrates an example of the visual text grounding system utilizing the machine learning model dataset to evaluate the OCR-based visual text grounding ability of multimodal large language models in accordance with one or more embodiments;

FIG. 10 illustrates the results of an ablation study of the visual text grounding system utilizing multi-level image patch selection in accordance with one or more embodiments;

FIGS. 11A-11B illustrate qualitative examples of data instances of a machine learning model dataset generated by the visual text grounding system 106 in accordance with one or more embodiments;

FIG. 12 illustrates a diagram of an example architecture of the visual text grounding system in accordance with one or more embodiments;

FIG. 13 illustrates a flowchart of a series of acts of the visual text grounding system generating a text answer and a text description in accordance with one or more embodiments;

FIG. 14 illustrates a flowchart of a series of acts of the visual text grounding system identifying a text answer to a text question from grounding image patches in accordance with one or more embodiments;

FIG. 15 illustrates a flowchart of a series of acts of the visual text grounding system generating a machine learning model dataset in accordance with one or more embodiments; and

FIG. 16 illustrates a block diagram of an example computing device in accordance with one or more embodiments.

### DETAILED DESCRIPTION

This disclosure describes one or more embodiments of a visual text grounding system that trains, utilizes, and/or evaluates multimodal large language models in visual text grounding including identifying grounding text content within digital images that support text answers to text questions. For example, the disclosed systems receive a text question associated with a digital image that includes text content. In one or more embodiments, the disclosed systems generate a large language model prompt that includes the digital image, the text question, and an instruction to generate a text answer for the text question. In certain embodiments, the disclosed systems generate the large language model prompt to include an instruction to identify a portion of the text content of the digital image that supports the text answer for the text question (e.g., identify grounding text content and/or grounding shape(s)). Utilizing the large language model prompt, certain embodiments of the disclosed systems prompt a multimodal large language model to generate a text answer to the text question from the text content of the digital image. Furthermore, in some embodiments, the disclosed systems prompt the multimodal large language model to generate a text description that identifies grounding text content supporting the text answer

More specifically, in one or more embodiments, the visual text grounding system utilizes an instruction-based method to train, utilize, and/or evaluate multimodal large language models. For example, embodiments of the visual grounding system train multimodal large language models using an instruction-based method by treating the grounding task as an instruction-following task using iterative next token prediction. In some cases, the visual text grounding system trains (and/or evaluates) the multimodal large language models to generate text answers for text questions and associated text descriptions that identify bounding shapes enclosing grounding text within the digital image that supports the text answers. In some embodiments, the visual text grounding system utilizes OCR preprocessing to provide OCR text information to train (and/or evaluate) the multimodal large language models using an OCR-based instruction-based method. In some embodiments, the visual text grounding system 106 trains (and/or evaluates) the multimodal large language models utilizing an OCR-free instruction-based method without OCR preprocessing.

In one or more embodiments, the visual text grounding system utilizes an embedding-based method to train, utilize, and/or evaluate the multimodal large language models. For example, using the embedding-based method, the visual text grounding system trains (and/or evaluates) the multimodal large language models in visual text grounding by prompting the multimodal large language models to generate image patch embeddings and text token embeddings. In certain embodiments, the visual text grounding system compares the image patch embeddings and text token embeddings to select grounding image patches that correspond to the locations of supporting grounding text within digital images. Embodiments of the visual text grounding system utilize the embedding-based method to determine grounding text and the grounding shape(s) utilizing the pixels of the selected grounding image patches. In some embodiments, the visual text grounding system utilizes OCR preprocessing to provide OCR text information to train (and/or evaluate) the multimodal large language models using an OCR-based embedding-based method. In some embodiments, the visual text grounding system 106 trains (and/or evaluate) the multimodal large language models utilizing an OCR-free embedding-based method without OCR preprocessing.

In certain embodiments, the visual text grounding system 106 generates machine learning model datasets for training and evaluating the performance of multimodal large language models in visual text grounding. For example, the visual text grounding system 106 generates baseline datasets for training multimodal large language models to identify grounding text within digital images for questions-answer pairs utilizing a dataset generation pipeline. In one or more embodiments, the visual text grounding system utilizes a dataset generation pipeline that includes an OCR processing model, a grounding shape selection model, and a grounding shape assessment model.

To illustrate, in one or more embodiments, the visual text grounding system 106 utilizes an OCR processing model to perform OCR processing and identify text content and corresponding bounding shapes. In addition, the visual text grounding system 106 utilizes a grounding shape selection model to select bounding shapes from the bounding shapes provided by the OCR model that support the text answers for the text questions. Furthermore, the visual text grounding system 106 utilizes a grounding shape assessment model to assess the accuracy of the bounding shapes selected by the grounding shape selection model. In some cases, if the grounding shape assessment model determines the selected bounding shapes are inadequate to provide support for the text answer, embodiments of the visual text grounding system prompt the grounding shape selection model to select additional bounding shapes that support the text answer (repeating the bounding shape selection up to a threshold number of iterations).

As mentioned, existing systems have a number of shortcomings, particularly in terms of accuracy, computational efficiency, and efficacy when identifying grounding shapes that support text queries based on digital image content. For example, existing systems are often inaccurate when performing visual text grounding. With many existing systems, despite an ability of multimodal large language models to generate accurate outputs in other contexts, multimodal large language models frequently suffer from hallucinations due to insufficient visual text grounding capabilities. The insufficient visual text grounding capabilities of existing systems are due in part to a predominant focus of existing grounding techniques on natural images (associating textual descriptions with objects or scenes), without adjusting for the complexities inherent in text-rich multimodal digital images. As a result, multimodal large language models trained using existing systems suffer from inaccurate visual text grounding when processing rich-text digital images such as scanned forms, structured reports, and complex infographics that require precise text localization. For example, instead of accurately identifying and associating text across various digital image formats, with some existing systems, the multimodal large language models incorrectly align grounding shapes with incorrect spatial locations in a digital image (e.g., selecting visual content for “Subtotal” instead of “Total”).

Additionally, some existing systems exhibit computational inefficiencies in visual text grounding. For example, many existing systems rely on methods that sequentially process content for visual text grounding, requiring multimodal large language models to handle visual text grounding in a step-by-step manner, thus increasing computational costs and resulting in higher latency. Furthermore, these existing systems often store and process entire sequences in memory for each operation, leading to excessive GPU and CPU memory consumption, especially for complex multimodal images.

Furthermore, many existing systems are ineffective when generating grounding shapes for visual text grounding. This is due in part to the treatment of visual text grounding by existing systems as an intermediate step rather than a primary objective. As a result, existing systems often fail to produce verifiable grounding text content, reducing their effectiveness in tasks that require precise text localization to identify the source of text answers. Furthermore, with existing systems, the inability to distinguish and verify grounding text content reduces the adaptability and verifiability of multimodal large language models, limiting their ability to generalize across diverse multimodal digital image types.

The lack of a standardized evaluation framework for visual text grounding further limits the effectiveness of existing systems and inhibits the performance of multimodal large language models in visual text grounding. Without dedicated instruction and benchmarking datasets tailored to visual text grounding, existing systems deliver unreliable performance for real-world scenarios that utilize multimodal digital images. Additionally, without well-structured instruction datasets and standardized baseline methods, existing systems are unable to reliably generalize visual text grounding across different types of multimodal digital images. As a result, the multimodal large language models of existing systems often require extensive fine-tuning and manual intervention, reducing their efficiency and scalability in real-world use cases requiring visual text grounding.

As suggested above, embodiments of the visual text grounding system overcome these and other disadvantages inherent in existing systems. For example, unlike previous models that rely on nonspecific grounding techniques developed for natural images, the visual text grounding system aligns grounding shapes with supportive text content in multimodal digital images. Using a specific grounding process tailored to visual text grounding, embodiments of the visual text grounding system minimize hallucinations and enable precise associations between grounding shapes and text content. Unlike existing systems that struggle with combinations of text and graphical elements, embodiments of the visual text grounding system utilize a machine learning model dataset to train/evaluate multimodal large language models in visual text grounding based on a diverse multimodal dataset.

Furthermore, the visual text grounding system is more effective than existing systems. In certain embodiments, the visual text grounding system utilizes an embedding-based method to separate the visual text grounding capability from the instruction following capability of multimodal large language models. For example, many multimodal large language models are not capable of following complex customized instructions for visual text grounding to accurately identify, locate, and associate grounding text in a digital image. To address this, certain embodiments of the visual text grounding system utilize an embedding-based method that improves the accuracy of visual text grounding for multimodal large language models, particularly for multimodal large language models with limited instruction following capabilities.

Additionally, embodiments of the visual text grounding system provide improvements in computational efficiency in relation to existing models. Instead of sequentially generating responses token by token, embodiments of the visual text grounding system utilize an embedding-based method to represent and evaluate image content using embeddings, eliminating the need for iterative processing. By utilizing an embedding-based method, the visual text grounding system reduces GPU and CPU memory consumption, especially for complex multimodal images. Furthermore, in certain embodiments, the visual text grounding system incorporates an embedding-based modular component that enables multimodal large language models to perform visual text grounding without complete retraining or modifications to core architecture.

Furthermore, the visual text grounding system enhances overall visual text grounding efficacy of multimodal large language models by directly addressing challenges associated with processing text-rich multimodal digital images. Rather than treating visual text grounding as an intermediate process, the visual text grounding system trains multimodal large language models in visual text grounding as a core functionality, enhancing both baseline performance and document grounding capabilities. By incorporating advanced multimodal analysis techniques, the visual text grounding system trains multimodal large language models to adapt to various multimodal image layouts, ensuring reliable performance across a diverse range of multimodal digital images. In this way, embodiments of the visual text grounding system train multimodal large language models to provide verifiable and contextually accurate responses, making the visual text grounding system effective for processing a variety of multimodal digital images including scanned forms, structured reports, and complex infographics.

In one or more embodiments, the visual text grounding system provides enhancements in visual text grounding by generating a specialized machine learning model dataset and evaluation framework for training and/or evaluating the visual text grounding capabilities of multimodal large language models. Unlike existing systems that lack structured benchmark datasets, the visual text grounding system provides a standardized dataset for training and assessing multimodal large language models in visual text grounding for multimodal digital images. In this way, the visual text grounding system improves the generalization of multimodal large language models in visual text grounding across diverse multimodal document types, reducing the need for extensive fine-tuning and/or adjustments. By generating a tailored machine learning model dataset, the visual text grounding system significantly improves the scalability and reliability of the training and evaluation processes for multimodal large language models in visual text grounding.

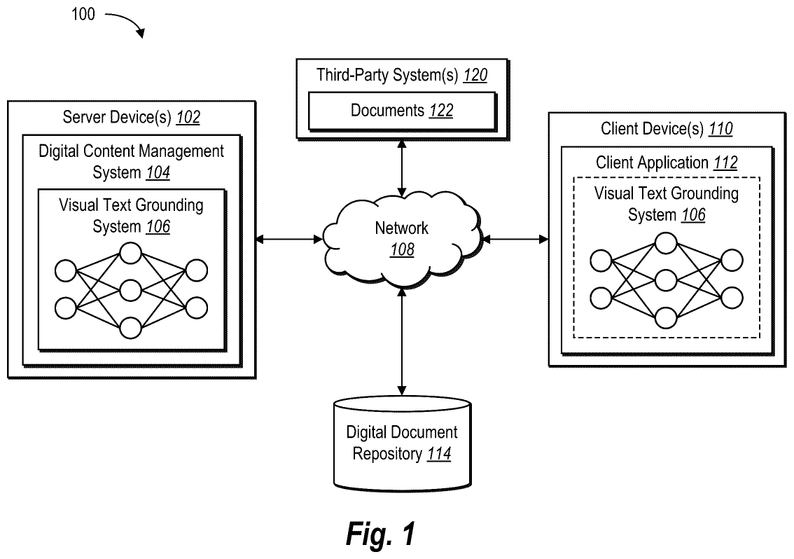

Additional detail regarding the visual text grounding system will now be provided with reference to the figures. For example, FIG. 1 illustrates a schematic diagram of an exemplary system environment (e.g., environment 100) in which a visual text grounding system 106 operates. As illustrated in FIG. 1, the environment 100 includes server device(s) 102, a network 108, client device(s) 110, digital document repository 114, and third-party system(s) 120.

Although the environment 100 of FIG. 1 is depicted as having a particular number of components, the environment 100 is capable of having any number of additional or alternative components (e.g., any number of servers, client devices, or other components) in communication with the visual text grounding system 106 via the network 108. Similarly, although FIG. 1 illustrates a particular arrangement of the server device(s) 102, the network 108, the client device(s) 110, the digital document repository 114, and the third-party system(s) 120, various additional arrangements are possible.

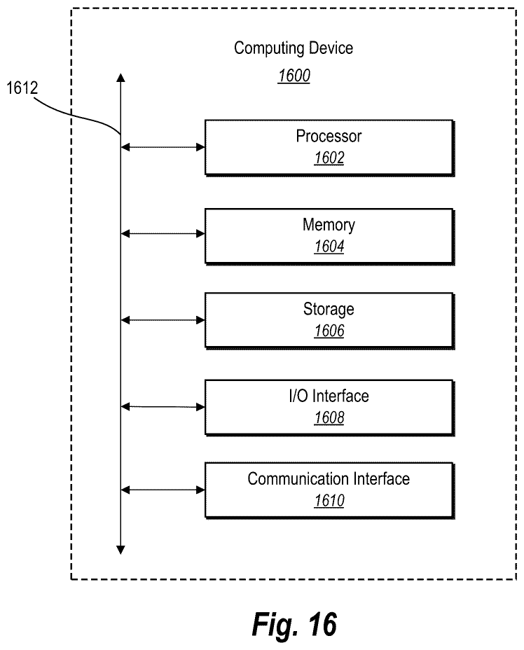

The server device(s) 102, the network 108, the client device(s) 110, the digital document repository 114, and the third-party system(s) 120 are communicatively coupled with each other either directly or indirectly (e.g., through the network 108 discussed in greater detail below in relation to FIG. 16). Moreover, the server device(s) 102 and the client device(s) 110 include one of a variety of computing devices (including one or more computing devices as discussed in greater detail with relation to FIG. 16).

As illustrated in FIG. 1, the environment 100 includes the server device(s) 102 and the digital content management system 104. The server device(s) 102 utilizes the digital content management system 104 to generate, track, store, process, receive, and transmit electronic data including digital images, image content, image patch embeddings, text token embeddings, grounding shapes, grounding text, and machine learning model datasets. For example, the server device(s) 102 receives or monitors interactions across the client device(s) 110. In some embodiments, the server device(s) 102 transmits content to the client device(s) 110 to cause the client device(s) 110 to display and execute content associated with identifying grounding text content and/or generating machine learning model datasets. For example, the server device(s) 102 presents the digital images, image content, image patch embeddings, text token embeddings, grounding shapes, grounding text, and/or machine learning model datasets to client device(s) 110 and displays and/or determines the digital images, image content, image patch embeddings, text token embeddings, grounding shapes, grounding text, and/or machine learning model datasets on the client device(s) 110 with the digital images, image content, image patch embeddings, text token embeddings, grounding shapes, grounding text, and/or machine learning model datasets, displayed and/or determined corresponding to system need (e.g., digital images, image content, image patch embeddings, text token embeddings, grounding shapes, grounding text, and/or machine learning model datasets for display and/or determination via the client application 112). The server device(s) 102 further accesses and utilizes the digital document repository 114 to store and retrieve information such as digital images, image content, image patch embeddings, text token embeddings, grounding shapes, grounding text, machine learning model datasets, and/or other data.

Additionally, the server device(s) 102 includes all, or a portion of, the visual text grounding system 106. For example, the visual text grounding system 106 operates on the server device(s) 102 to access digital content (including digital images, image content, image patch embeddings, text token embeddings, grounding shapes, grounding text, and machine learning model datasets), determine digital content changes, execute digital content, and provide localization of content changes to the client device(s) 110 and/or finetune large language models. In one or more embodiments, via the server device(s) 102, the visual text grounding system 106 generates, executes, and displays digital images, image content, image patch embeddings, text token embeddings, grounding shapes, grounding text, and machine learning model datasets based on the client device(s) 110 input. Example components of the visual text grounding system 106 will be described below with regard to FIG. 16.

Furthermore, as shown in FIG. 1, the illustrated system includes the client device(s) 110. In some embodiments, the client device(s) 110 include, but are not limited to, mobile devices (e.g., smartphones, tablets), laptop computers, desktop computers, or another type of computing devices, including those explained below in reference to FIG. 16. Some embodiments of client device(s) 110 are operated by a user to perform a variety of functions via client application 112 such as the generation/modification of the digital images, image content, image patch embeddings, text token embeddings, grounding shapes, grounding text, and machine learning model datasets. The client device(s) 110 include one or more applications (e.g., the client application 112) that access, edit, modify, store, execute, and/or provide, for display, digital images, image content, image patch embeddings, text token embeddings, grounding shapes, grounding text, and machine learning model datasets. For example, in some embodiments, the client application 112 includes a software application installed on the client device(s) 110. In other cases, however, the client application 112 includes a web browser or other application that accesses a software application hosted on the server device(s) 102.

In one or more embodiments, the visual text grounding system 106 is implemented in whole, or in part, by the individual elements of the environment 100. Indeed, as shown in FIG. 1, the visual text grounding system 106 is implemented with regard to the server device(s) 102 and the client device(s) 110. In particular embodiments, the visual text grounding system 106 on the client device(s) 110 comprises a web application, a native application installed on the client device(s) 110 (e.g., a mobile application, a desktop application, a plug-in application, etc.), or a cloud-based application where part of the functionality is performed by the server device(s) 102.

In additional or alternative embodiments, the visual text grounding system 106 on the client device(s) 110 represents and/or provides the same or similar functionality as described herein in connection with the visual text grounding system 106 on the server device(s) 102. In some embodiments, the visual text grounding system 106 on the server device(s) 102 supports the visual text grounding system 106 on the client device(s) 110.

In some embodiments, the visual text grounding system 106 includes a web hosting application that allows the client device(s) 110 to interact with content and services hosted on the server device(s) 102. To illustrate, in one or more embodiments, the client device(s) 110 accesses a web page or computing application supported by the server device(s) 102. The client device(s) 110 provides input to the server device(s) 102 (e.g., user interactions). In response, the visual text grounding system 106 on the server device(s) 102 generates and/or determines digital images, image content, image patch embeddings, text token embeddings, grounding shapes, grounding text, and/or machine learning model datasets. The server device(s) 102 then provides the digital images, image content, image patch embeddings, text token embeddings, grounding shapes, grounding text, and/or machine learning model datasets to the client device(s) 110.

In some embodiments, the visual text grounding system 106 includes the third-party system(s) 120 and document renderer application 122. To illustrate, in one or more embodiments, the visual text grounding system 106 interacts with content and services hosted on the third-party system(s) 120. To illustrate, in one or more embodiments, the visual text grounding system 106 accesses a web page or computing application supported by the third-party system(s) 120. The third-party system(s) 120 provide input to the visual text grounding system 106 and document renderer application 122. In response, the visual text grounding system 106 generates/modifies digital content including digital images, image content, image embeddings, token embeddings, grounding shapes, grounding text, and machine learning model datasets and/or interacts with the document renderer application 122 to generate/modify digital content including digital images, image content, image patch embeddings, text token embeddings, grounding shapes, grounding text, and/or machine learning model datasets. The visual text grounding system 106 then provides the digital content to the third-party system(s) 120.

In some embodiments, though not illustrated in FIG. 1, the environment 100 has a different arrangement of components and/or has a different number or set of components altogether. For example, in certain embodiments, the client device(s) 110 communicate directly with the server device(s) 102, bypassing the network 108. As another example, the environment 100 includes a third-party server comprising a content server and/or a data collection server.

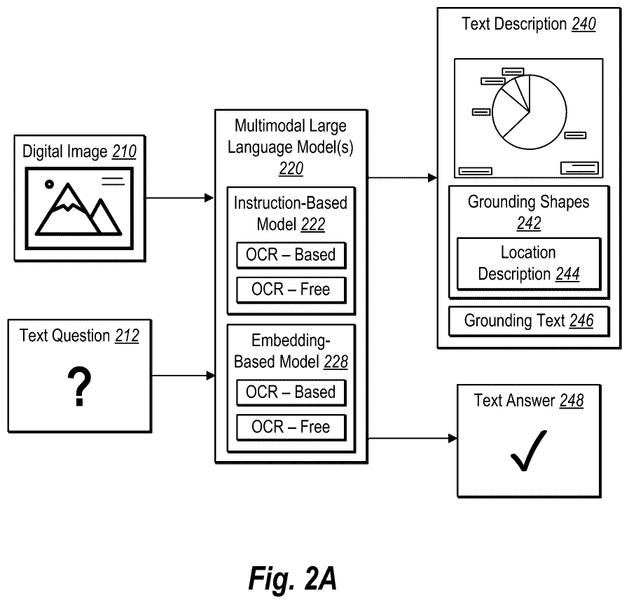

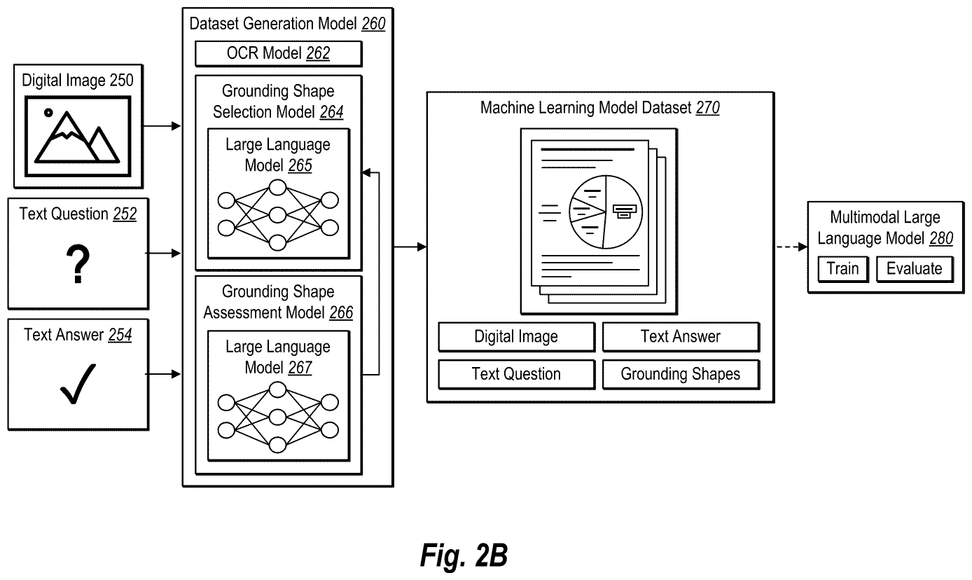

As previously mentioned, in one or more embodiments, the visual text grounding system 106 identifies supportive grounding content within a multimodal digital image that supports an answer to a text question. For instance, FIG. 2A illustrates an example overview of the visual text grounding system 106 generating a text answer for a text question and identifying supportive grounding shapes based on text content of a digital image in accordance with one or more embodiments. Additional detail regarding the various acts of FIG. 2A is provided thereafter with reference to subsequent figures.

In one or more embodiments, as shown in FIG. 2A, the visual text grounding system 106 trains, utilizes, and/or evaluate multimodal large language model(s) 220 in visual text grounding. In one or more embodiments, the term visual text grounding includes or refers to identifying and localizing supportive textual content within a digital image. For example, visual text grounding includes identifying grounding text 246 and grounding shapes 242 within a digital image 210 that support a text answer 248 to a text question 212. In some cases, visual text grounding includes identifying the grounding text 246 that supports the text answer 248 to the text question 212 in association with a spatial position in the digital image 210 by localizing the spatial coordinates of the grounding text 246. For example, embodiments of the visual text grounding system 106 perform visual text grounding by generating a text description 240 identifying the grounding shapes 242 that encapsulate grounding content (e.g., localizing the spatial position of the grounding text 246).

To illustrate, embodiments of the visual text grounding system 106 generate the text answer 248 from the textual content of the digital image 210. In some cases, the visual text grounding system 106 accesses the digital image 210 via an image rendering application-such as an image rendering application that accesses, edits, modifies, stores, and/or displays digital images. In one or more embodiments, the digital image 210 includes or refers a visual representation of information stored in a digital format, composed of pixels that encode color and intensity values. For example, the digital image 210 includes a multimodal digital image that integrates textual and visual content such as scanned forms, invoices, receipts, reports, charts, infographics, and text-rich graphics such as posters and book covers. For example, the digital image 210 includes various multimodal digital image types such as invoices, forms, receipts, reports, letters, historical documents, bar charts, pie charts, line graphs, scatter plots, histograms, box plots, posters, flyers, advertisements, educational infographics, posters, book covers, and text-rich images.

As shown in FIG. 2A, the visual text grounding system 106 receives a text question 212 associated with the digital image 210. In one or more embodiments, the text question 212 includes a query posed about the content of the digital image 210 that is answerable based on the textual content of the digital image 210. In certain embodiments, the visual text grounding system 106 trains the multimodal large language model(s) 220 to generate the text answer 248 to address or resolve the text question 212 based on the textual content of the digital image 210.

As further shown in FIG. 2A, embodiments of the visual text grounding system 106 train the multimodal large language model(s) 220 to generate a text description 240. For example, the visual text grounding system 106 trains the multimodal large language model(s) 220 to generate the text description 240 corresponding to the text answer 248. For example, the text description 240 identifies grounding content (e.g., grounding shapes 242 and grounding text 246) of the digital image 210 that supports the text answer 248 to the text question 212.

In one or more embodiments, the text description 240 includes the grounding text 246. As mentioned, the grounding text 246 includes or refers to textual content within the digital image 210 that supports the text answer 248 to the text question 212. In some cases, the grounding text 246 includes the textual content of the digital image 210 that the visual text grounding system 106 determines to be semantically aligned with the text answer 248 based on contextual, structural, and relational cues within the digital image 210.

In certain embodiments, the text description 240 includes grounding shapes 242 that correspond to the grounding text 246. For example, the grounding shapes 242 include or refer to geometric regions in the digital image 210 that enclose the grounding text 246. In some cases, the grounding shapes 242 include rectangles, polygons, ellipses, or other geometric outlines that identify the grounding text 246 such that the grounding text 246 is visually and spatially distinguished within the digital image 210. In one or more embodiments, the grounding shapes tightly encapsulate the text, ensuring that only relevant content (e.g., the grounding text 246) is included, avoiding extraneous elements.

In some embodiments, the visual text grounding system 106 identifies the grounding shapes 242 utilizing a location description 244. In certain embodiments, the visual text grounding system 106 utilizes the location description 244 including identifying spatial coordinates that define the boundaries of the bounding shape within the digital image 210. In certain cases, the visual text grounding system 106 utilizes a location description 244 identifying coordinates in pixel values relative to the dimensions of the digital image 210. In some cases, the location description 244 utilizes a binary mask or a segmentation map that defines pixels of the digital image 210 as the grounding shapes 242 (e.g., a bitmap overlay on the image).

As mentioned, embodiments of the visual text grounding system 106 train, utilize, and/or evaluate a multimodal large language model(s) 220 in visual text grounding including identifying the grounding text 246 within the digital image 210 that supports the text answer to the text question 212. To elaborate, as used herein a large language model includes or refers to a machine learning model trained to perform computational tasks to generate textual content. A large language model includes a computer algorithm or a collection of computer algorithms trainable and/or tunable based on inputs to approximate unknown functions. A large language model includes a neural network (e.g., a deep neural network) that analyzes a language input to generate a predicted output. For example, a large language model includes a neural network that generates answers to questions from a natural language query. In some cases, the large language model utilizes a transformer architecture, which includes mechanisms such as self-attention, to capture contextual relationships in the data.

Relatedly, as used herein, a multimodal large language model (MLLM) includes or refers to a large language model that extends this capability by incorporating visual and textual information for multimodal reasoning. A multimodal large language model includes a neural network trained on both textual and visual data, allowing the model to analyze image-based inputs, such as scanned documents, charts, and infographics, alongside textual queries. For example, a multimodal large language model includes an architecture that processes document images, grounding text within visual layouts to enhance contextual understanding. Like large language models, multimodal large language models utilize self-attention mechanisms but extend them to cross-modal attention, enabling the fusion of language and image representations for tasks such as visual question answering (VQA), document understanding, and text-image alignment.

For example, a large language model and/or a multimodal large language model includes a computer algorithm with branches, weights, or parameters that change based on training data to improve for a particular task. Thus, a large language model or a multimodal large language model utilizes one or more learning techniques (e.g., supervised or unsupervised learning) to improve in accuracy and/or effectiveness. Similarly, as used herein, a neural network refers to a machine learning model of interconnected nodes (or neurons) organized into layers. A neural network includes parameters or weights between neurons that are adjusted during training to minimize the error (or measure of loss) in generating predictions.

Along these lines, the machine learning models used herein are trainable and/or fine-tunable based on a diverse text corpora to perform natural language processing tasks and multimodal analysis tasks. For example, the machine learning models consist of layers of interconnected artificial neurons organized in encoder and decoder blocks, which learn complex language patterns to generate textual content or align textual queries with visual data. In some cases, the machine learning models include models or architectures that utilize self-attention and cross-attention mechanisms for natural language understanding and multimodal content analysis. In particular, in certain embodiments, a large language model or multimodal large language model refers to an artificial neural network trained by the visual text grounding system 106 to generate text, interpret digital image content, and extract structured information from multimodal sources.

As illustrated in FIG. 2A, embodiments of the visual text grounding system 106 utilize an instruction-based method 222 to train, utilize, and/or evaluate the multimodal large language model(s) 220 in visual text grounding. For example, utilizing the instruction-based method 222, the visual text grounding system 106 trains the multimodal large language model(s) 220 to identify a portion of the text content of the digital image 210 that supports the text answer 248 (e.g., the text description 24). In certain embodiments, the visual text grounding system 106 utilizes autoregressive techniques to train the multimodal large language model(s) 220 in visual text grounding for the instruction-based method 222. Utilizing autoregressive techniques, embodiments of the visual text grounding system 106 train the multimodal large language model(s) 220 utilizing iterative next token prediction. As also shown, embodiments of the visual text grounding system 106, utilize the instruction-based method 222 with OCR preprocessing (e.g., OCR-based) and without OCR preprocessing (e.g., OCR-free) to train and/or evaluate the multimodal large language model(s) 220.

In one or more embodiments, the visual text grounding system 106 utilizes an embedding-based method 228 to train, utilize, and/or evaluate the multimodal large language model(s) 220 in visual text grounding. In one or more embodiments, for the embedding-based method 228, the visual text grounding system 106 trains the multimodal large language model(s) 220 to generate image patch embeddings and text token embeddings. In certain embodiments, the visual text grounding system 106 compares the image patch embeddings and text token embeddings to select grounding image patches that correspond to the spatial locations of the grounding text 246 within the digital image 210. Embodiments of the visual text grounding system 106 evaluate the embedding-based method 228 by comparing the selected grounding image patches to ground truth bounding shapes. As also shown in FIG. 2A, embodiments of the visual text grounding system 106, utilize OCR-based and OCR-free methods to train and evaluate the multimodal large language model(s) 220 for the embedding-based method 228.

As mentioned, embodiments of the visual text grounding system 106 include a pipeline for generating machine learning model datasets for training and evaluating the performance of multimodal large language models in visual text grounding. FIG. 2B illustrates an example of the visual text grounding system generating a machine learning model dataset for training and/or evaluating multimodal large language models in accordance with one or more embodiments.

As shown in FIG. 2B, the visual text grounding system 106 utilizes a dataset generation model 260 to generate a machine learning model dataset 270 to train and/or evaluate a multimodal large language model 280 in visual text grounding. For example, the visual text grounding system 106 receives or accesses a digital image 250. In one or more embodiments, the visual text grounding system 106 utilizes an OCR model 262 to extract textual information from the digital image 250. In some cases, the visual text grounding system 106 utilizes the OCR model 262 to extract textual content from the digital image and identify bounding shapes corresponding to the spatial location of the textual content in the digital image 250.

In one or more embodiments, the visual text grounding system 106 utilizes a grounding shape selection model 264 to select candidate bounding shapes that support a text answer 254 for a text question 252. For example, the visual text grounding system 106 utilizes a grounding shape selection model 264 to select the candidate bounding shapes by selecting a subset of the bounding shapes generated by the OCR model 262 that support the text answer 254 for the text question 252. In one or more embodiments, the visual text grounding system 106 selects the candidate bounding shapes utilizing a text bounding image that aligns the textual elements of the digital image 250 with the bounding shapes. Based on the text bounding image, embodiments of the visual text grounding system 106 prompt the large language model 265 to select the candidate bounding shapes that support the text answer 254 that corresponds to the text question 252.

As also shown, in certain embodiments, the visual text grounding system 106 utilizes a grounding shape assessment model 266 to assess the accuracy (or relevance) of the candidate bounding shapes selected by the grounding shape selection model 264. For example, the grounding shape assessment model 266 prompts the large language model 267 to assess whether the candidate bounding shapes provide adequate support for the text answer 254. If the large language model 267 determines the candidate bounding shapes provide adequate support for the text answer 254, embodiments of the visual text grounding system 106 add the associated data instance (e.g., the digital image 250, the text question 252, the text answer 254, and the candidate bounding shapes) to the machine learning model dataset 270.

In some cases, if the grounding shape assessment model 266 determines the selected bounding shapes are inaccurate, or are inadequate to support the text answer 254, embodiments of the visual text grounding system 106 perform additional iterations to generate additional candidate grounding shapes for the digital image 250. For example, the visual text grounding system 106 utilizes the grounding shape selection model 264 to prompt the large language model 265 to generate additional candidate grounding shapes by selecting an additional subset of the bounding shapes generated by the OCR model 262 that support the text answer 254 for the text question 252. Furthermore, the visual text grounding system 106 utilizes the grounding shape assessment model 266 to determine if the additional candidate grounding shapes are adequate to provide support for the text answer 254.

In one or more embodiments, the dataset generation model 260 performs iterations to generate additional candidate bounding shapes until the grounding shape assessment model 266 determines the candidate bounding shape provide adequate support to result in the text answer 254. In some cases, after a threshold number of iterations, if the grounding shape selection model 264 determines the selected further bounding shape fail to support the text answer 254, the visual text grounding system 106 omits the associated data instance (e.g., the digital image 250, the text question 252, the text answer 254, and the candidate bounding shapes) from the machine learning model dataset 270.

As described above, the machine learning model dataset 270 includes or refers to a multimodal dataset for training and evaluating the performance of a multimodal large language model 280 in visual text grounding. In some cases, the machine learning model dataset 270 includes sample data instances that incorporate a multimodal digital image, text question, text answer, and grounding shapes. In certain embodiments, the visual text grounding system 106 generates a diverse selection for the machine learning model dataset 270 utilizing varied content types for the digital image 250. For example, the visual text grounding system 106 utilizes a variety of multimodal image types for the digital image 250, such as invoices, forms, receipts, reports, letters, historical documents, bar charts, pie charts, line graphs, scatter plots, histograms, box plots, posters, flyers, advertisements, educational infographics, posters, book covers, and text-rich images to generate the machine learning model dataset 270.

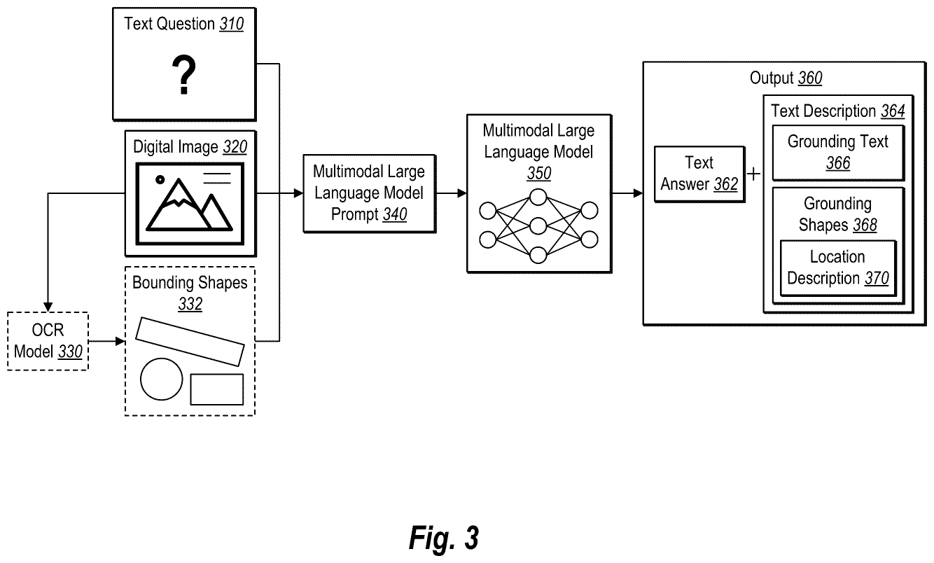

As mentioned, one or more embodiments of the visual text grounding system 106 utilize an instruction-based method to generate a text answer for a text question and a corresponding text description that supports the text answer. FIG. 3 illustrates an example of the visual text grounding system 106 utilizing an instruction-based method to generate a text answer and a text description in accordance with one or more embodiments.

As shown in FIG. 3, in one or more embodiments, the visual text grounding system 106 utilizes an instruction-based method to prompt a multimodal large language model 350 in visual text grounding. For example, the visual text grounding system 106 prompts the multimodal large language model 350 to generate the output 360 including the text answer 362 to a text question 310 and a text description 364 that supports the text answer 362. In some embodiments, the visual text grounding system 106 determines the grounding text 366 and the grounding shapes 368 from the output 360 For example, the visual text grounding system 106 determines the grounding shapes 368 encompassing the grounding text 366 that supports the text answer 362. In some cases, the visual text grounding system 106 utilizes a location description 370, such as numerical coordinates or relative position descriptors that identify the grounding shapes 368 including locations, dimensions, and/or spatial coordinates of the grounding shapes 368 within the digital image 320.

In one or more embodiments, the visual text grounding system 106 utilizes an OCR-free instruction-based method to prompt the multimodal large language model to generate the output 360. For example, the visual text grounding system 106 prompts the multimodal large language model 350 to generate the text answer 362 and the text description 364 without utilizing OCR preprocessing (e.g., without utilizing bounding shapes 332). For the OCR-free instruction-based method, embodiments of the visual text grounding system 106 generate the multimodal large language model prompt 340 from the text question 310, the digital image 320, and an instruction guiding a multimodal large language model 350 to generate the output 360.

To illustrate, in one or more embodiments, the visual text grounding system 106 utilizes the OCR-free instruction-based method to prompt the multimodal large language model 350 to generate the output 360 utilizing an autoregressive loss function that incorporates the digital image 320, the text question 310, and previously generated tokens. For example, the multimodal large language model 350 sequentially generates tokens in an output sequence including the text answer 362 and the text description 364. In one or more embodiments, the visual text grounding system 106 utilizes a loss function such as:

$${L}_{θ} = - {\sum }_{j = 1}^{l} log {p}_{θ} ( {y}_{j}^{′} \vert Image , x , {y}_{< j}^{′} ) , {y}^{′} = [ y ; {b}_{1} ; … ; {b}_{G} ] ,$$

where x represents the multimodal large language model prompt 340, Image represents the digital image 320, and the sequence of tokens y′ represents the output 360. In certain embodiments, the visual text grounding system 106 defines the output 360 as y′=[y; b₁; . . . ; b_{G}], where y′ represents the text answer 362 (e.g., y) concatenated with the grounding text 366 (e.g., b₁; . . . ; b_{G}). In some cases, the visual text grounding system 106 defines the output 360 as y′=[y; b₁; . . . ; b_{G}], where y′ represents the text answer 362 (e.g., y) concatenated with the text description 364 (e.g., grounding text 366 and the location description 370 (b₁; . . . ; b_{G})). In some cases, the visual text grounding system 106 utilizes regular expressions to extract the text answer 362 and/or the location description 370 from the output 360 (e.g., [y; b₁; . . . ; b_{G}]).

As further shown in FIG. 3, in one or more embodiments, the visual text grounding system 106 utilizes an OCR-based instruction-based method to prompt the multimodal large language model 350 to generate the text answer 362 and the text description 364 utilizing an OCR model 330. For example, the visual text grounding system 106 prompts the multimodal large language model 350 to select the grounding shapes 368 from a subset of the bounding shapes 332 generated by an OCR model 330.

For example, for the OCR-based instruction-based method, the visual text grounding system 106 utilizes the OCR model 330 to process the digital image 320 and generate bounding shapes 332 corresponding to the textual content within the digital image 320. In one or more embodiments, for the OCR-based instruction-based method, the visual text grounding system 106 generates the multimodal large language model prompt 340 from the text question 310, the digital image 320, the bounding shapes 332, and an instruction guiding a multimodal large language model 350 generate the output 360. Furthermore, the visual text grounding system 106 prompts the multimodal large language model 350 to select the grounding shapes 368 as a subset of the bounding shapes 332 that support the text answer 362.

Similar to the OCR-free instruction-based method, embodiments of the visual text grounding system 106 incorporate a token-prediction framework to prompt the multimodal large language model 350 to generate the output 360 including the text answer 362 and the text description 364. For example, the visual text grounding system 106 utilizes the OCR-based instruction method to prompt the multimodal large language model 350 to generate the output 360 by sequentially generating tokens based on the digital image 320, the text question 310, the bounding shapes 332, and previously generated tokens as described by a function such as:

$${L}_{θ} = - {\sum }_{j = 1}^{l} log {p}_{θ} ( {y}_{j}^{′} \vert Image , {x}^{′} , {y}_{< j}^{′} )$$

$${x}^{′} = [ x ; {b}_{1} ; … ; {b}_{N} ] , {y}^{′} = ⌈ y ; {b}_{1}^{′} ; … ; {b}_{G}^{′} ]$$

where x′=[x; b₁; . . . ; b_{N}] represents the multimodal large language model prompt 340, N represents the number of the bounding shapes 332, Image represents the digital image 320, and the sequence of tokens y′ represents the output 360.

In certain embodiments, the visual text grounding system 106 defines the output 360 as

$${y}^{′} = [ y ; {b}_{1}^{′} ; … ; {b}_{G}^{′} ] ,$$

where y′ represents the text answer 362 (e.g., y) concatenated with the grounding text 366

$$( e . g . , {b}_{1}^{′} ; … ; {b}_{G}^{′} ) and {b}_{1}^{′}$$

represents the first selected bounding shape (which may be different from b₁). In one or more embodiments, the visual text grounding system 106 defines the output 360 as

$${y}^{′} = ⌈ y ; {b}_{1}^{′} ; … ; {b}_{G}^{′} ] ,$$

where y′ represents the text answer 362 (e.g., y) concatenated with the text description 364 (e.g., grounding text 366 and the location description 370

$$( e . g . , [ y ; {b}_{1}^{′} ; … ; {b}_{G}^{′} ] ) .$$

As further illustrated in FIG. 3, embodiments of the visual text grounding system 106 utilize the OCR-based instruction-based method to generate the location description 370 corresponding to the grounding text 366. In one or more embodiments, for the OCR-based instruction-based method, the visual text grounding system 106 determines the grounding shapes 368 by identifying a subset of the bounding shapes 332 that encompass the grounding text 366. In some cases, the visual text grounding system 106 determines the location description 370 by identifying coordinates in the digital image that represent the grounding shapes 368 that encompass the grounding text 366. In some cases, the visual text grounding system 106 utilizes regular expressions to extract the text answer 362 and/or the location description 370 from the output 360

$$( e . g . , [ y ; {b}_{1}^{′} ; … ; {b}_{G}^{′} ] ) .$$

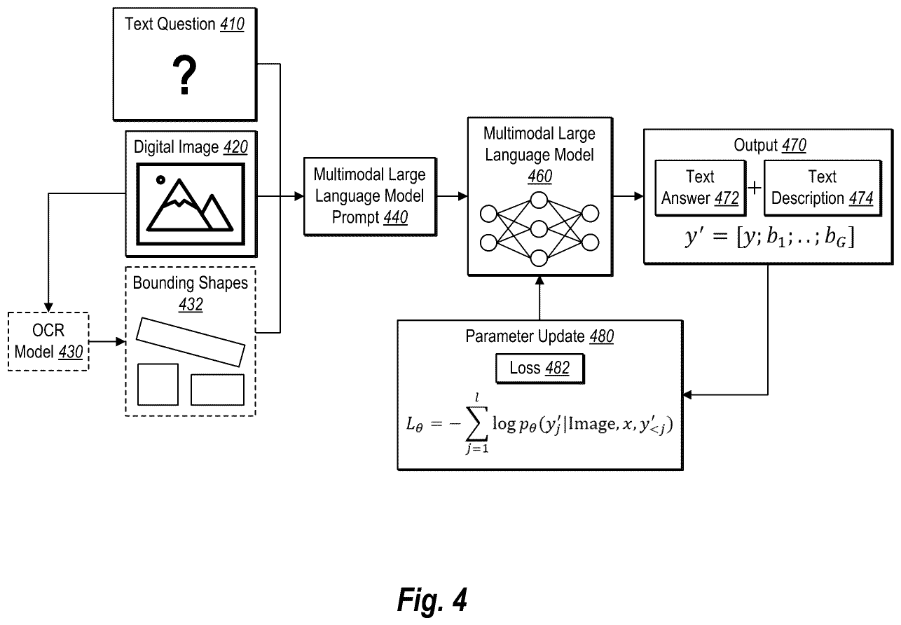

As mentioned, one or more embodiments of the visual text grounding system 106 utilize an instruction-based training method to train multimodal large language models to generate text answers for text questions and determine corresponding grounding shapes encapsulate supportive grounding text. FIG. 4 illustrates an example of the visual text grounding system utilizing an instruction-based training method to train a multimodal large language model to generate a text answer and text description in accordance with one or more embodiments.

As shown in FIG. 4, in one or more embodiments, the visual text grounding system 106 utilizes an instruction-based training method to train a multimodal large language model 460 in visual text grounding. For example, the visual text grounding system 106 generates a multimodal large language model prompt 440 to prompt the multimodal large language model 460 to generate an output 470. Utilizing the multimodal large language model prompt 440, the visual text grounding system 106 prompts the multimodal large language model 460 to generate the output 470 (e.g., a text answer 472 and a text description 474) corresponding to a text question 410 for a digital image 420. Furthermore, the visual text grounding system 106 determines a loss 482 by comparing the text answer 472 and the text description 474 to a ground truth answer and ground truth text description. Embodiments of visual text grounding system 106 perform a parameter update 480 to update the parameters of the multimodal large language model 460 to minimize the loss 482.

As shown in FIG. 4, in one or more embodiments, the visual text grounding system 106 utilizes an OCR-free instruction-based training method and/or an OCR-based instruction-based training method to train a multimodal large language model 460 in visual text grounding. To elaborate, in one or more embodiments, the visual text grounding system 106 utilizes an OCR-free instruction-based training method to train the multimodal large language model 460 in visual text grounding without utilizing OCR preprocessing (e.g., without utilizing bounding shapes 432). Utilizing the OCR-free instruction-based method, embodiments of the visual text grounding system 106 generate the multimodal large language model prompt 440 from the text question 410, the digital image 420, and an instruction guiding the multimodal large language model 460 to generate the output 470.

As further shown, embodiments of the visual text grounding system 106 prompt the multimodal large language model 460 to generate the output 470 utilizing the multimodal large language model prompt 440. Based on the multimodal large language model prompt 440, the multimodal large language model 460 generates an output 470 as a sequence of tokens. In certain embodiments, the output 470 includes the text answer 472 and the text description 474.

In one or more embodiments, the visual text grounding system 106 updates the multimodal large language model 460 based on the loss 482. For example, the visual text grounding system 106 performs the parameter update 480 for the multimodal large language model 460 by adjusting the parameters of the multimodal large language model 460 to minimize the loss 482. In one or more embodiments, the visual text grounding system 106 determines the loss 482 utilizing a negative log-likelihood formula such as:

$${L}_{θ} = - {\sum }_{j = 1}^{l} log {p}_{θ} ( {y}_{j}^{′} \vert Image , x , {y}_{< j}^{′} ) , {y}^{′} = [ y ; {b}_{1} ; … ; {b}_{G} ] ,$$

where x represents the multimodal large language model prompt 340, Image represents the digital image 320, the sequence of tokens y′ represents the output 360, and pe represents the multimodal large language model 350 with parameters θ. In certain embodiments, the visual text grounding system 106 defines the output 470 as y′=[y; b₁; . . . ; b_{G}], where y′ represents the text answer 362 (e.g., y) concatenated with grounding text tokens representing the text description 474 (e.g., b₁; . . . ; b_{G}).

As mentioned, one or more embodiments of the visual text grounding system 106 utilize an OCR-based instruction-based training method to train the multimodal large language model 460. For example, for the OCR-based instruction-based training method, the visual text grounding system 106 utilizes an OCR model 430 to generate the bounding shapes 432 corresponding to textual content within the digital image 420. For the OCR-based instruction-based training method, embodiments of the visual text grounding system 106 generate the multimodal large language model prompt 440 from the text question 410, the digital image 420, the bounding shapes 432, and an instruction guiding a multimodal large language model 460 to generate the output 470.

In one or more embodiments, for the OCR-based instruction-based training method, the visual text grounding system 106 prompts the multimodal large language model 460 to generate the output 470 utilizing the multimodal large language model prompt 440. Based on the multimodal large language model prompt 440, the multimodal large language model 460 generates the output 470 as a sequence of tokens representing the text answer 472 and the text description 474.

In one or more embodiments, the visual text grounding system 106 updates the multimodal large language model 460 based on the loss 482. For example, the visual text grounding system 106 performs the parameter update 480 for the multimodal large language model 460 by adjusting the parameters of the multimodal large language model 460 to minimize the loss 482. With the OCR-based instruction-based training method, embodiments of the visual text grounding system 106 determine the loss 482 utilizing a negative log-likelihood formula such as:

$${L}_{θ} = - {\sum }_{j = 1}^{l} log {p}_{θ} ( {y}_{j}^{′} \vert Image , {x}^{′} , {y}_{< j}^{′} )$$

$${x}^{′} = [ x ; {b}_{1} ; … ; {b}_{N} ] , {y}^{′} = [ y ; {b}_{1}^{′} ; … ; {b}_{G}^{′} ]$$

where x′=[x; b₁; . . . ; b_{N}] represents the multimodal large language model prompt 440 N represents the number of the bounding shapes 432, Image represents the digital image 420, the sequence of tokens y′ represents the output 470, and pe represents the multimodal large language model 460 with parameters θ. In certain embodiments, the visual text grounding system 106 defines the output 470 as

$${y}^{′} = ⌈ y ; {b}_{1}^{′} ; … ; {b}_{G}^{′} ] ,$$

where y′ represents the text answer 472 (e.g., y) concatenated with the text description 474

$$( e . g . , {b}_{1}^{′} ; … ; {b}_{G}^{′} ) .$$

As illustrated in FIG. 4, in one or more embodiments, the visual text grounding system 106 performs multiple iterations of the instruction-based training method (the OCR-free instruction-based training method and/or the OCR-based instruction-based training method). In some cases, the visual text grounding system 106 performs training iterations until the loss 482 stabilizes over a specific number of epochs. In some embodiments, the visual text grounding system 106 trains the multimodal large language model 460 for a specified number of iterations. In some embodiments, the visual text grounding system 106 performs training iterations based on the output 470 satisfying a grounding shape accuracy metric (e.g., Intersection over Union (IoU), precision, recall, F1 score).

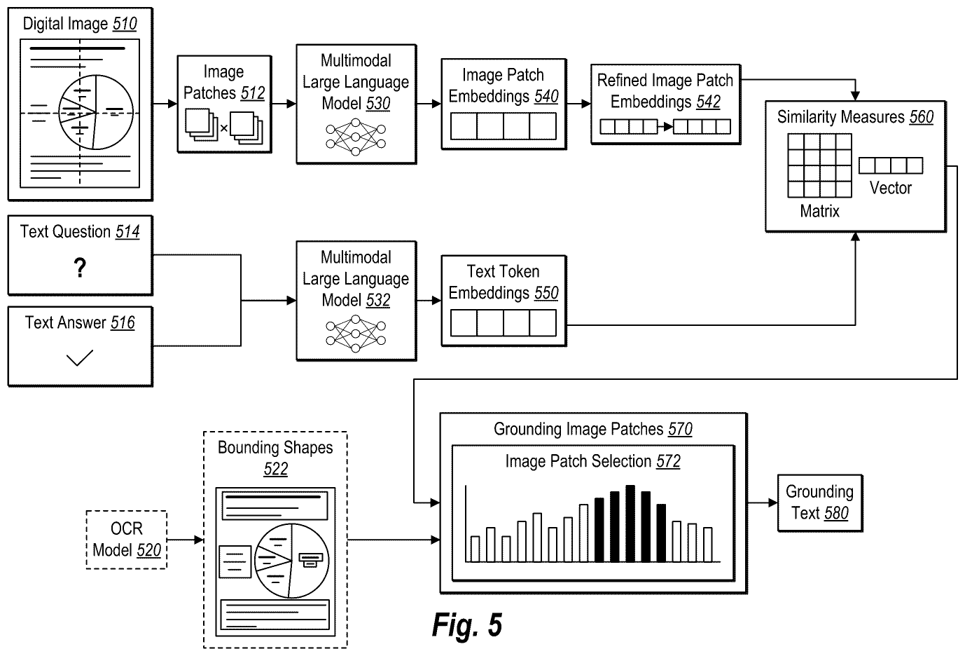

As mentioned, one or more embodiments of the visual text grounding system 106 utilize an embedding-based method to generate a text answer for a text question and a corresponding text description that supports the text answer. FIG. 5 illustrates an example of the visual text grounding system 106 utilizing an embedding-based method to identify grounding text content in accordance with one or more embodiments.

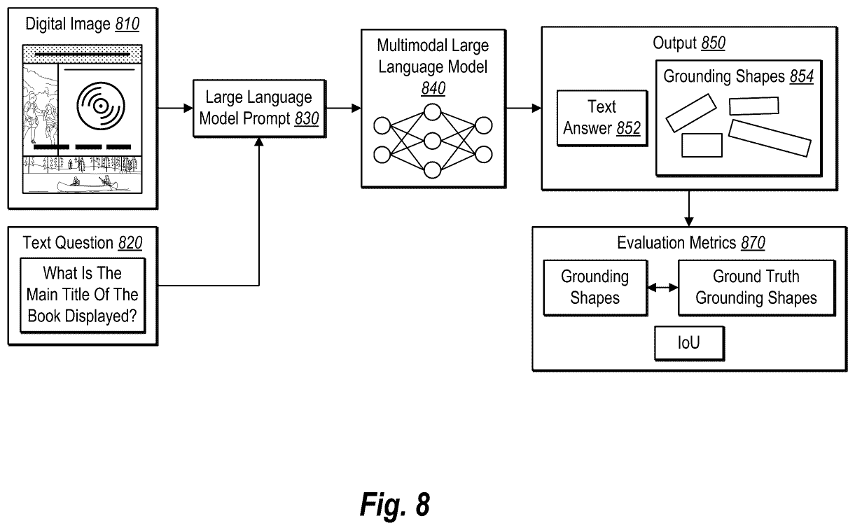

In some cases, the visual text grounding system 106 utilizes an embedding-based method to reduce a reliance on the instruction-following capability of the multimodal large language models. For example, as illustrated in relation to FIGS. 8-10, when using instruction-based methods, the instruction-following capability of the multimodal large language models effects visual text grounding accuracy. However, by utilizing an embedding-based method, certain embodiments of the visual text grounding system 106 reduce the impact of the instruction-following capability of the multimodal large language models on visual text grounding accuracy. In this way, certain embodiments of the visual text grounding system 106 trains the visual text grounding capability of multimodal large language models apart from the instruction-following capability of the multimodal large language models.

To illustrate, as shown in FIG. 5, the visual text grounding system 106 utilizes an embedding-based method to identify grounding text 580. Specifically, the visual text grounding system 106 identifies the grounding text 580 based on generating and selecting the grounding image patches 570 that support a text answer 516 for a text question 514.

In one or more embodiments, for the embedding-based method, the visual text grounding system 106 prompts the multimodal large language model 530 to generate image patch embeddings 540 from the digital image 510. For example, the visual text grounding system 106 divides the digital image 510 into the image patches 512 such as non-overlapping uniformly size patches (e.g., 32×32 pixels). In addition, the visual text grounding system 106 prompts the multimodal large language model 530 to generate the image patch embeddings 540 from image patches 512. In some cases, the visual text grounding system 106 denotes the image patch embeddings 540 as H^{Image}ϵ [symbol] ^{l}^{_{image}}^{xD}, where l_{image} is the number of image patches and D is the dimension of the embeddings. Furthermore, the visual text grounding system 106 utilizes

$${H}_{i}^{Image}$$

to represent the ith image patch embedding of the image patch embeddings 540.

As shown, in one or more embodiments, the visual text grounding system 106 prompts a multimodal large language model 532 to generate the text token embeddings 550. For example, the visual text grounding system 106 provides the text question 514 and the text answer 516 to a multimodal large language model 532 to generate the text token embeddings 550. In some cases, the visual text grounding system 106 concatenates the text question 514 and the text answer 516 to generate the text token embeddings 550. In some cases, the visual text grounding system 106 denotes the text token embeddings 550 as H^{Text}ϵ [symbol] ^{l}^{_{Text}}^{xD}, where l_{Text} is the number of text tokens and

$${H}_{i}^{Text}$$

represents the ith text token embedding of the text token embeddings 550.

In certain embodiments, the visual text grounding system 106 utilizes the same multimodal large language model for the multimodal large language model 530 to generate the image patch embeddings 540 and the multimodal large language model 532 to generate the text token embeddings 550.

To account for textual content that spans multiple image patches, in some embodiments, the visual text grounding system 106 generates refined image patch embeddings 542 from the image patch embeddings 540. For example, the visual text grounding system 106 merges information from nearby patches with the image patch embeddings 540 to generate the refined image patch embeddings 542 and account for image content that spans several adjacent (or nearby) patches. In one or more embodiments, the visual text grounding system 106 generates the refined image patch embeddings 542 as the average of the image patch embeddings

$${H}_{i}^{Image}$$

and the surrounding image patch embeddings, such that:

$${H}_{i}^{{Image}^{′}} = \frac{1}{\vert N ( i ) \vert} {\sum }_{j ∈ N ( i )} {H}_{j}^{Image}$$

where

$${H}_{i}^{{Image}^{′}}$$

represents the refined image patch embedding for the ith image patch and N(i) represents the set of indices for the ith image patch and the surrounding patches. In this way, certain embodiments of the visual text grounding system 106 utilize the refined image patch embeddings 542 to complete the semantic information for the image patch embeddings 540 and improve the accuracy for the similarity measures 560 for the image patch embeddings 540 (e.g., avoiding inaccurately low or inaccurately high similarity values).

In certain embodiments, the visual text grounding system 106 generates similarity measures 560. For example, the visual text grounding system 106 utilizes the similarity measures 560 to indicate a likelihood of the image patches 512 containing grounding content that supports the text answer 516. To illustrate, the visual text grounding system 106 generates the similarity measures 560 based on the refined image patch embeddings 542 and the text token embeddings 550. In one or more embodiments, the visual text grounding system 106 compares the refined image patch embeddings 542 and the text token embeddings 550 to determine which of the refined image patch embeddings 542 have the greatest similarities with the text token embeddings 550.

In one or more embodiments, the visual text grounding system 106 determines the similarity measures 560 utilizing a matrix composed of vectors representing the similarity for the refined image patch embeddings 542. For example, the visual text grounding system 106 generates a similarity vector from the similarity measures 560 by combining sets of the similarity measures 560 for respective image patches across the text token embeddings 550. In one or more embodiments, the visual text grounding system 106 determines similarity vectors Sϵ [symbol] ^{l}^{_{image}} that represent a similarity for each of the refined image patches embedding

$${H}_{i}^{{Image}^{′}}$$

to the text token embeddings 550 averaged over the text embedding space, such as:

$${S}_{i} = \frac{1}{{l}_{Text}} {\sum }_{k = 1}^{{l}_{Text}} 〈 {H}_{i}^{{Image}^{′}} , {H}_{k}^{Text} 〉$$

where Sᵢ represents the ith component of the similarity vector (e.g., similarity vector), l_{Text} is the

$$〈 {H}_{i}^{{Image}^{′}} , {H}_{k}^{Text} 〉$$

number of the text token embeddings 550, and represents the dot product between the refined image patch embeddings 542 and the text token embeddings 550.

As further shown in FIG. 5, the visual text grounding system 106 performs an image patch selection 572 to select the grounding image patches 570 based on the similarity measures 560. For example, the visual text grounding system 106 performs the image patch selection 572 to select the image patches 512 that correspond to the top-k values for the similarity measures 560 (e.g., based on the top-k refined image patch embeddings with the greatest similarity to the set of the text token embeddings 550). For example, the visual text grounding system 106 performs the image patch selection 572 by selecting the image patches 512 corresponding to the refined image patch embeddings 542 with the top-k values for the similarity measures 560 where k is a pre-defined number such as 3, 4, 5. In certain embodiments, the visual text grounding system 106 determines the grounding image patches 570 based on the image patch selection 572 (e.g., selecting k image patches).

In one or more embodiments, the visual text grounding system 106 performs a multi-level selection for the image patch selection 572 to generate the grounding image patches 570. To illustrate, the visual text grounding system 106 identifies surrounding image patches to the top-k image patches in the digital image 510 (e.g., additional sets of the top-k image patches) and similarity measures for the surrounding image patches based on a comparison of the text token embeddings 550 to a set of image patch embeddings for the surrounding image patches. Furthermore, the visual text grounding system 106 progressively adds the surrounding image patches (e.g., the additional sets of the top-k image patches) to generate the grounding image patches 570. In some cases, the visual text grounding system 106 performs the image patch selection 572 by selecting the image patches 512 corresponding to the refined image patch embeddings 542 with the top-k values for the similarity measures 560 in combination with the next top-k values to the image patch selection 572 (e.g., top-5, top-10, top-15).

In some cases, the visual text grounding system 106 adds the surrounding image patches to the image patch selection 572 only if the surrounding image patches are within a threshold distance within the digital image 510 of the previously selected image patches. In one or more embodiments, the visual text grounding system 106 performs a specified number of multi-level selections of top-k image patches from the image patches 512 to generate the grounding image patches 570.

As further shown in FIG. 5, embodiments of the visual text grounding system 106, utilize the grounding image patches 570 to generate the grounding text 580 indicating the text answer 516 to the text question 514. In one or more embodiments, the visual text grounding system 106 selects the grounding text 580 as the textual content of the digital image 510 contained within the image patches 512 that supports the text answer 516 to the text question 514. For example, embodiments of the visual text grounding system 106 determine the grounding text 580 based the textual content of the digital image 510 represented by the pixels corresponding to the grounding image patches 570 (e.g., an OCR-free embedding-based method).

Relatedly, as discussed in relation to FIGS. 8-10, the visual text grounding system 106 evaluates the performance of the multimodal large language model 530 and/or the multimodal large language model 532 for the OCR-free embedding-based method utilizing the pixels corresponding to the grounding image patches 570. For example, for the OCR-free embedding based method, the visual text grounding system 106 evaluates the performance of the multimodal large language model 530 by comparing the pixels of the grounding image patches to ground truth bounding shapes.

As also shown in FIG. 5, in one or more embodiments, the visual text grounding system 106 utilizes an OCR-based embedding-based method to generate the grounding text 580 indicating the text answer 516 to the text question 514. For example, using the OCR-based embedding-based method, the visual text grounding system 106 utilizes an OCR model 520 to determine bounding shapes 522 corresponding to textual content within the digital image 510 that supports the text answer 516 to the text question 514. In some cases, using the OCR-based embedding-based method, the visual text grounding system 106 selects grounding shapes corresponding to a subset of the bounding shapes 522 that overlap with the grounding image patches 570. Furthermore, in some cases, the visual text grounding system 106 determines the grounding text 580 as the textual content of the digital image 510 encompassed by the grounding shapes.

Relatedly, as discussed in relation to FIGS. 8-10, the visual text grounding system 106 evaluates the performance of the multimodal large language model 530 and/or the multimodal large language model 532 for the OCR-based embedding-based method utilizing the grounding shapes. For example, for the OCR-based embedding based method, the visual text grounding system 106 evaluates the performance of the multimodal large language model 530 by comparing the grounding shapes that overlap with the grounding image patches 570 to ground truth bounding shapes.

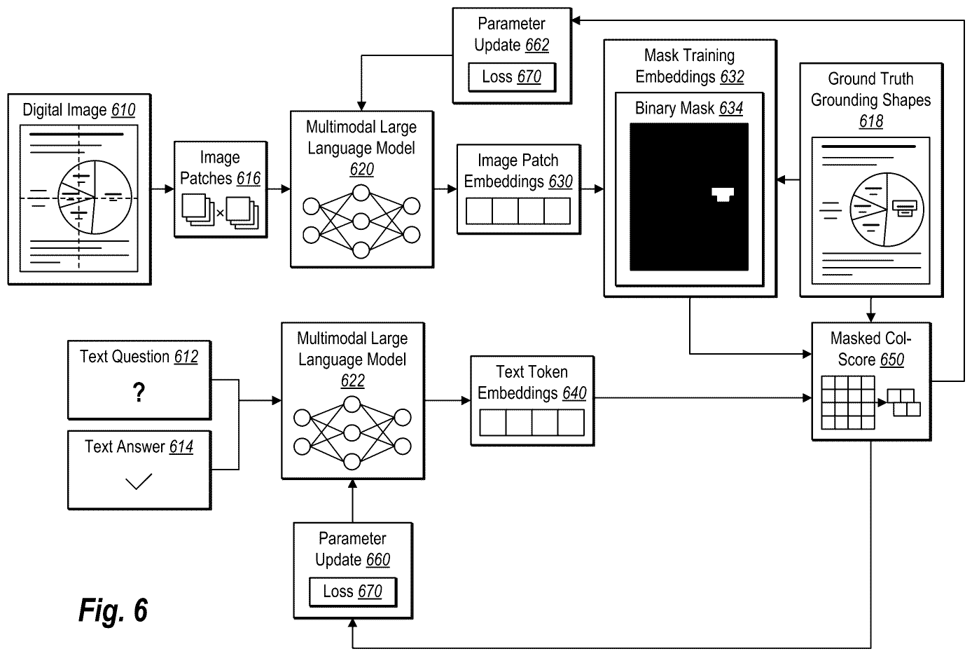

As mentioned, in one or more embodiments, the visual text grounding system 106 trains multimodal large language models in visual text grounding utilizing an embedding-based training model. For example, the visual text grounding system 106 trains multimodal large language models in visual text grounding by finetuning the multimodal large language models in encoding image patch embeddings and text token embeddings. FIG. 6 illustrates an example of the visual text grounding system utilizing an embedding-based training method to train multimodal large language models to generate embeddings used to identify grounding text content in accordance with one or more embodiments.

As shown in FIG. 6, in one or more embodiments, the visual text grounding system 106 utilizes the embedding-based training method to prompt a multimodal large language model 622 to generate text token embeddings 640 from a text question 612 and a text answer 614. In one or more embodiments, the visual text grounding system 106 concatenates the text question 612 and the text answer 614 to generate the text token embeddings 640.

As also shown, the visual text grounding system 106 prompts a multimodal large language model 620 to generate image patch embeddings 630 from the digital image 610. For example, the visual text grounding system 106 divides the digital image 610 into image patches 616 such as non-overlapping uniformly size patches (e.g., 32×32 pixels). In addition, the visual text grounding system 106 prompts the multimodal large language model 620 to generate the image patch embeddings 630 from image patches 616. In certain embodiments, the visual text grounding system 106 utilizes the same multimodal large language model for the multimodal large language model 620 and the multimodal large language model 622.

In one or more embodiments, the visual text grounding system 106 applies a binary mask 634 to the image patch embeddings 630 to generate mask training embeddings 632. For example, the visual text grounding system 106 generates the binary mask 634 (e.g., M) where Mᵢ=1 for image patches overlapping with the ground truth grounding shapes 618 and Mᵢ=0 for image patches not overlapping with the ground truth grounding shapes 618. By applying the binary mask 634 to the image patch embeddings 630, the visual text grounding system 106 generates mask training embeddings 632 based on an overlap of the image patches 616 with ground truth grounding shapes 618 that encapsulate the ground truth grounding text of the digital image 610.

As further shown in FIG. 6, the visual text grounding system 106 utilizes a masked col-score 650 to train the multimodal large language model 620 and the multimodal large language model 622. For example, the visual text grounding system 106 defines an interaction matrix X, where

$${X}_{i , j} = {H}_{i}^{Text} \cdot {( {H}_{i}^{Text} )}^{T}$$

between the text token embeddings 640 and the image patch embeddings 630. In some cases, the visual text grounding system 106 utilizes a modified contextualized late interaction score defined on the interaction matrix X to determine a masked col-score 650. In one or more embodiments, the visual text grounding system 106 further determines a masked col-score 650 as:

$$s ( X , M ) = {\sum }_{i = 1}^{n} {max}_{\{ j : {M}_{j} = 1 \}} {X}_{i , j}$$

In some cases, the visual text grounding system 106 utilizes the hardest negative pairs (e.g., incorrect pairings between the mask training embeddings 632 and the text token embeddings that yield the highest values for the masked col-score 650) to determine a loss 670. For example, the visual text grounding system 106 denotes positive pairings as interaction matrices X⁺ and negative pairings as interaction matrices X⁻.

In one or more embodiments, the visual text grounding system 106 trains the multimodal large language model 620 and the multimodal large language model 622 utilizing the loss 670. For example, the visual text grounding system 106 performs a parameter update 662 to update the parameters of the multimodal large language model 620 to minimize the loss 670 and a parameter update 660 to update the parameters of the multimodal large language model 622. In one or more embodiments, the visual text grounding system 106 utilizes a loss 670 such as determined by the function:

$${L}_{InfoCE} = - log ( \frac{{e}^{( s ( {X}^{+} , M ) / τ )}}{{e}^{( s ( {X}^{+} , M ) / τ )} + {e}^{( s ( {X}^{-} , 1 ) / τ )}} )$$

where 1 is a vector of ones. In some cases, the visual text grounding system 106 simplifies the loss 670 to utilize a function such as:

L=Softplus(s(X⁻,M))−s(X⁺,1))

As shown, the visual text grounding system 106 utilizes a loss 670 designed to maximize the similarity between the ground truth grounding shapes 618 and the text token embeddings 640 and minimize the similarity between the similarity for the hardest negative pair.

As illustrated in FIG. 6, in one or more embodiments, the visual text grounding system 106 performs multiple iterations of the embedding-based training model to train the multimodal large language model 620 and multimodal large language model 622. In some cases, the visual text grounding system 106 performs training iterations until the loss 670 stabilizes over a specific number of epochs (e.g., satisfies a threshold change value for a specified number of epochs). In some embodiments, the visual text grounding system 106 performs a specified number of iterations to train the multimodal large language model 620 and the multimodal large language model 622.

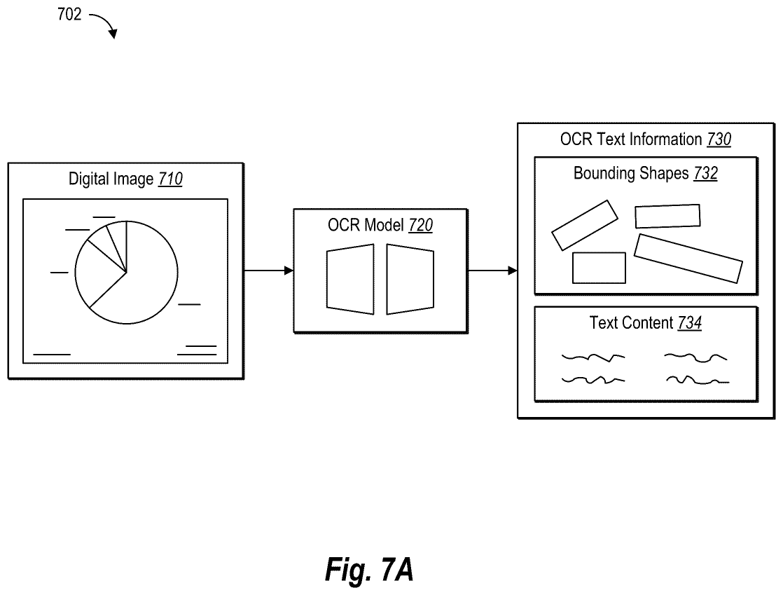

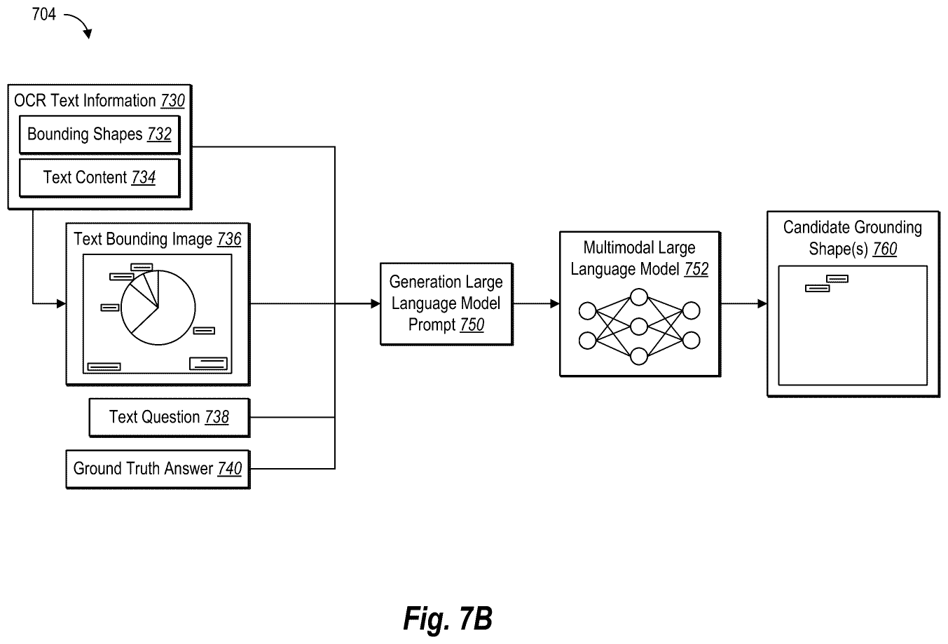

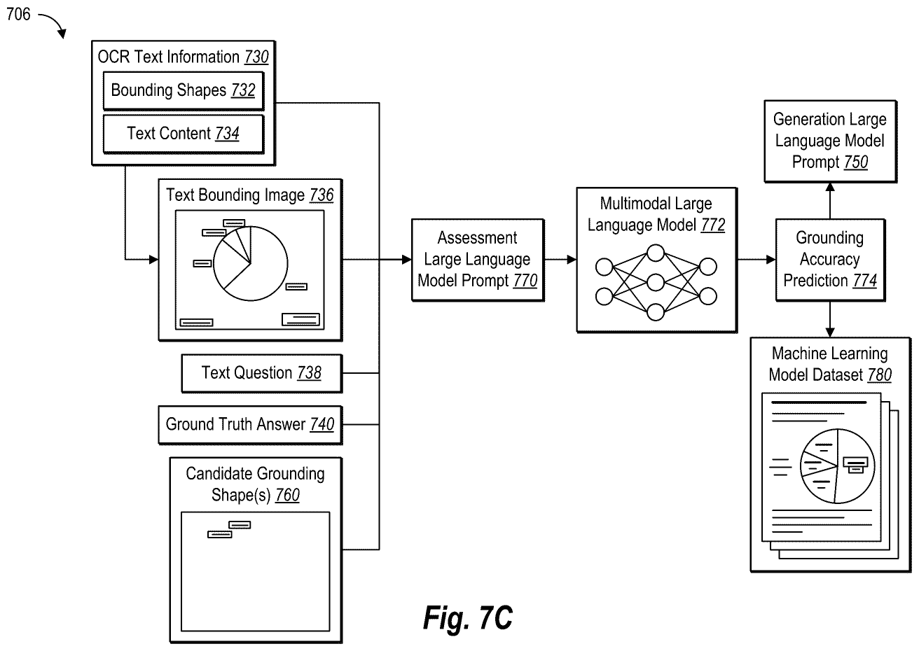

As mentioned, embodiments of the visual text grounding system 106 generate a comprehensive machine learning model dataset to for training and benchmarking multimodal large language models in visual text grounding. FIGS. 7A-7C illustrate an example of the visual text grounding system utilizing a dataset generation model to generate a machine learning model dataset in accordance with one or more embodiments.

As shown in FIG. 7A, the visual text grounding system 106 utilizes an OCR processing model 702 to generate OCR text information 730 for a digital image 710. For example, the visual text grounding system 106 receives or identifies the digital image 710. To increase diversity when generating a machine learning model dataset 780, in one or more embodiments, the visual text grounding system 106 utilizes a variety of sources for the digital image 710 for the OCR processing model 702. For example, the visual text grounding system 106 utilizes a variety of multimodal digital images that integrate textual and visual content. In some cases, the visual text grounding system 106 utilizes multimodal digital image types for the digital image 710 such as DocVQA (e.g., invoices, forms, receipts, reports, letters, historical documents), ChartQA (e.g., bar charts, pie charts, line graphs, scatter plots, histograms, box plots), InfographicVQA (e.g., posters, flyers, advertisements, educational infographics), and/or TRINS (e.g., posters, book covers, text-rich images).

As shown, embodiments of the visual text grounding system 106 utilize an OCR model 720 to extract the OCR text information 730 from the digital image 710. For example, the visual text grounding system 106 utilizes the OCR model 720 to identify bounding shapes 732 corresponding to text regions within the digital image 710. In some cases, the visual text grounding system 106 utilizes the OCR model 720 to generate the bounding shapes 732 corresponding to geometric structures that encompass the text content within the digital image (e.g., rectangles, ellipses, polygons). In addition, embodiments of the visual text grounding system 106 utilize the OCR model 720 to identify text content 734 within the digital image 710 by converting the extracted text into machine-readable characters.

As shown in FIG. 7B, in one or more embodiments, the visual text grounding system 106 utilizes a bounding shape generation model 704 to generate candidate grounding shape(s) 760 that support a ground truth answer 740 to a text question 738. To generate the candidate grounding shape(s) 760, embodiments of the visual text grounding system 106 generate a text bounding image 736 from the OCR text information 730. In some cases, the visual text grounding system 106 adds the bounding shapes 732 to the digital image 710 to encompass the text content within the digital image 710. For example, the visual text grounding system 106 generates the text bounding image 736 by aligning the bounding shapes 732 with the spatial position of the text content 734 within the digital image 250.

In some cases, generates the text bounding image 736 by linking the text content 734 in the text bounding image 736 to the bounding shapes 732. For example, the visual text grounding system 106 assigns distinct index values to each of the bounding shapes 732 of the text bounding image 736. Furthermore, embodiments of the visual text grounding system 106 visually mark the bounding shapes on the text bounding image 736 by adding the index values to the text bounding image 736.

Based on the text bounding image 736, embodiments of the visual text grounding system 106 generate a generation large language model prompt 750. For example, the visual text grounding system 106 generates a generation large language model prompt 750 to prompt the multimodal large language model 752 to select one or more of the bounding shapes 732 that support the ground truth answer 740 that corresponds to the text question 738. In some cases, the visual text grounding system 106 generates the generation large language model prompt 750 to prompt the multimodal large language model 752 to select the candidate grounding shape(s) 760 from the bounding shapes 732 based on the text bounding image 736. In one or more embodiments, the visual text grounding system 106 generates the generation large language model prompt 750 to include the text bounding image 736, the text question 738, the ground truth answer 740, the bounding shapes 732, the text content 734, and instructions to select the bounding shapes 732 that support the ground truth answer 740 to the text question 738.

In certain embodiments, the visual text grounding system 106 utilizes the generation large language model prompt 750 such as the following:

### System Prompt:

You are a helpful and precise assistant in finding the grounding bounding shape given the question-answer pair and the poster image.

### User Prompt

Question: {question}
Answer: {answer}
Above is the question and answer for a given poster.
Sentence-level bounding shape with indexes are provided in the poster, and detailed indexes with corresponding texts are also provided below:
{idx-text pairs}
Can you provide me with the indexes of bounding shape that can accurately and sufficiently lead to the answer?
Make sure you check both the poster image and the text provided above.
Please provide the index in the first line, use a comma to separate different indexes if more than one, and do not output anything else except for indexes or commas.
Please then provide the reason in the following lines on why you choose those bounding shape.
   In one or more embodiments, the visual text grounding system 106 prompts the multimodal large language model 752 utilizing the generation large language model prompt 750. Moreover, based on the generation large language model prompt 750, the multimodal large language model 752 selects the candidate grounding shape(s) 760 as a subset of the bounding shapes 732.

By including the index value in the generation large language model prompt 750 (via the text bounding image 736), embodiments of the visual text grounding system 106 explicitly align the text content 734 with the corresponding spatial locations in the digital image 710. In this way, embodiments of the visual text grounding system 106 provide a marked improvement in the ability of the multimodal large language model 752 to accurately select the candidate grounding shape(s) 760.

As shown in FIG. 7C, the visual text grounding system 106 utilizes a grounding shape assessment model 706 to evaluate whether the candidate grounding shape(s) 760 support the ground truth answer 740 to the text question 738. For example, the visual text grounding system 106 generates a correction large language model prompt 770 to prompt the multimodal large language model 752 generate the grounding accuracy prediction 774. In some cases, the visual text grounding system 106 prompts a multimodal large language model 772 to generate a grounding accuracy prediction 774 indicating whether the candidate grounding shape(s) 760 adequately supports the ground truth answer 740 to the text question 738.

To illustrate, the visual text grounding system 106 generates the correction large language model prompt 770 including the text bounding image 736, the text question 738, the ground truth answer 740, the bounding shapes 732, the text content 734, and instructions to generate the grounding accuracy prediction 774. In one or more embodiments, the visual text grounding system 106 utilizes the correction large language model prompt 770 such as the following:
System Prompt
   You are a helpful and precise assistant in analyzing the grounding bounding shape given the question-answer pair and the poster image.
User Prompt
   Question: {question}
   Answer: {answer}
   Above is the question and answer for a given poster.
   Sentence-level bounding shape with indexes are provided in the poster, and detailed indexes with corresponding texts are also provided below:
   {idx-text pairs}
   Do you think the bounding shape with index {idx-list} can accurately and sufficiently lead to the answer to the given question? Please output YES or NO in the first line, then provide the reason in the following lines
      Based on the generation large language model prompt 770, the multimodal large language model 772 generates the grounding accuracy prediction 774 indicating whether the candidate grounding shape(s) 760 adequately supports the ground truth answer 740 to the text question 738 (e.g., YES or NO).

As shown in FIG. 7C, based on the grounding accuracy prediction 774 indicating the candidate grounding shape(s) 760 adequately supports the ground truth answer 740 to the text question 738 (e.g., YES), the visual text grounding system 106 adds the candidate grounding shape(s) 760 to the machine learning model dataset 780. For example, the visual text grounding system 106 adds the candidate grounding shape(s) 760 associated with the digital image 710, the text question 738, and the ground truth answer 740 to the machine learning model dataset 780. As also shown, based on the grounding accuracy prediction 774 indicating the candidate grounding shape(s) 760 does not adequately support the ground truth answer 740 to the text question 738 (e.g., NO), the visual text grounding system 106 omits the candidate grounding shape(s) 760 from the machine learning model dataset 780.

In one or more embodiments, based on the grounding accuracy prediction 774 indicating the candidate grounding shape(s) 760 does not adequately support the ground truth answer 740 to the text question 738, the visual text grounding system 106 repeats the steps to generate one or more of the candidate grounding shape(s) 760 (as shown in FIG. 7B). For example, the visual text grounding system 106 prompts the multimodal large language model 752 to generate a new selection for the candidate grounding shape(s) 760 utilizing the generation large language model prompt 750. Embodiments of the visual text grounding system 106 repeat the steps of the grounding shape assessment model 706 for the digital image 710 for a threshold number of iterations or until the grounding accuracy prediction 774 indicates the candidate grounding shape(s) 760 adequately support the ground truth answer 740 to the text question 738. In one or more embodiments, if the candidate grounding shape(s) 760 does not adequately support the ground truth answer 740 to the text question 738 within the threshold number of iterations, the visual text grounding system 106 discards the digital image 710 from consideration for the machine learning model dataset 780.

As mentioned, embodiments of the visual text grounding system 106 provide an evaluation benchmark to evaluate the capabilities of multimodal large language models in visual text grounding utilizing the machine learning model dataset. FIG. 8 illustrates an example of the visual text grounding system 106 utilizing a machine learning model dataset for benchmarking the OCR-free visual text grounding capability of multimodal large language models in accordance with one or more embodiments.

For example, as shown in FIG. 8, the visual text grounding system 106 evaluates the limitations and constraints of multimodal large language models in visual text grounding tasks using an OCR-free visual text grounding evaluation. For the OCR-free visual text grounding evaluation, the visual text grounding system 106 provides multimodal large language model 840 with instructions for generating grounding shapes that have never been seen by the multimodal large language model 840 during training (and require a deep reasoning capability to correctly follow). In this way, the visual text grounding system 106 measures the visual text grounding capability in conjunction with the instruction following capability of the multimodal large language model 840.

In particular, as shown in FIG. 8, the visual text grounding system 106 evaluates the performance of the multimodal large language model 840 based on a large language model prompt 830 that includes a digital image 810, a text question 820, and an instruction generate an output 850 (e.g., text answer 852 and grounding shapes 854). For the OCR-free visual text grounding evaluation, the visual text grounding system 106 evaluates the performance of the multimodal large language model 840 when generating the grounding shapes 854 for the digital image 810 without utilizing OCR preprocessing. In one or more embodiments, the visual text grounding system 106 utilizes the large language model prompt 830 such as the following:

Prompt:
{question }
Please first answer the question according to the given image and
then generate the grounded text bounding shape that support your
answer. The width of the image is {width}px and the height is
{height}px. Please generate the bounding shape in the CSS format
textElement { {
} }
left: {left}px;
top: {top}px;
width: {width}px;
height {height}px;
content “{text}”;

To evaluate the performance of the multimodal large language model 840, embodiments of the visual text grounding system 106 compare the text answer 852 and the grounding shapes 854 generated by the multimodal large language model 840 to ground truth grounding shapes. In some cases, the visual text grounding system 106 utilizes a Pixel-level IoU (Intersection over Union) for an evaluation metric 870. For example, the visual text grounding system 106 calculates the overlap between the pixels in the grounding shapes 854 and ground truth grounding shapes, normalized by the total number of unique pixels.

As shown in Table 1 below, the visual text grounding system 106 outperforms existing systems in training multimodal large language models in OCR-free visual text grounding.

TABLE 1
OCR-Free Visual Text Grounding

| Testsets | Chart | Doc | Info | Trins | Avg |
|---|---|---|---|---|---|
| Metrics (%) | IoU | IoU | IoU | IoU | Avg |
| LLaVA-v1.6-Vicuna-7B | 0.00 | 0.00 | 0.00 | 0.00 | 0.00 |
| Phi3-V | 0.00 | 0.00 | 0.00 | 0.00 | 0.00 |
| DeepSeek-VL-7B-chat | 0.07 | 0.00 | 0.02 | 0.00 | 0.02 |
| CogVLM2-Llama3-19B | 0.19 | 0.01 | 0.16 | 0.66 | 0.25 |
| Monkey-Chat | 0.77 | 0.19 | 0.15 | 0.45 | 0.39 |
| MiniCPM-Llama3-V 2.5 | 0.44 | 1.40 | 0.65 | 4.96 | 1.86 |
| GPT-4o | 3.90 | 1.79 | 1.60 | 13.73 | 5.26 |
| VGT (Embedding) | 10.51 | 15.02 | 7.85 | 13.88 | 11.82 |
| VGT (Instruction) | 27.91 | 23.96 | 8.61 | 59.44 | 29.98 |

As shown by the results in Table 1, both the visual text grounding system 106 embedding-based method (e.g., VTG (Embedding)) and the visual text grounding system 106 instruction-based method (e.g., VTG (Instruction)) outperform models trained by existing systems by a large margin. For example, the visual text grounding system 106 embedding-based method reaches the average IoU of 10.0, and the visual text grounding system 106 instruction-based method reaches the average IoU of 29.98, compared with the 1.60 for GPT40. Notably, for OCR-free visual text grounding, even with further instructions requiring the multimodal large language models to generate grounding shapes that can support their answer, the existing multimodal large language models were still unable to follow the instructions-revealing a relatively weak spatial understanding of existing systems when generating grounding shapes from scratch.

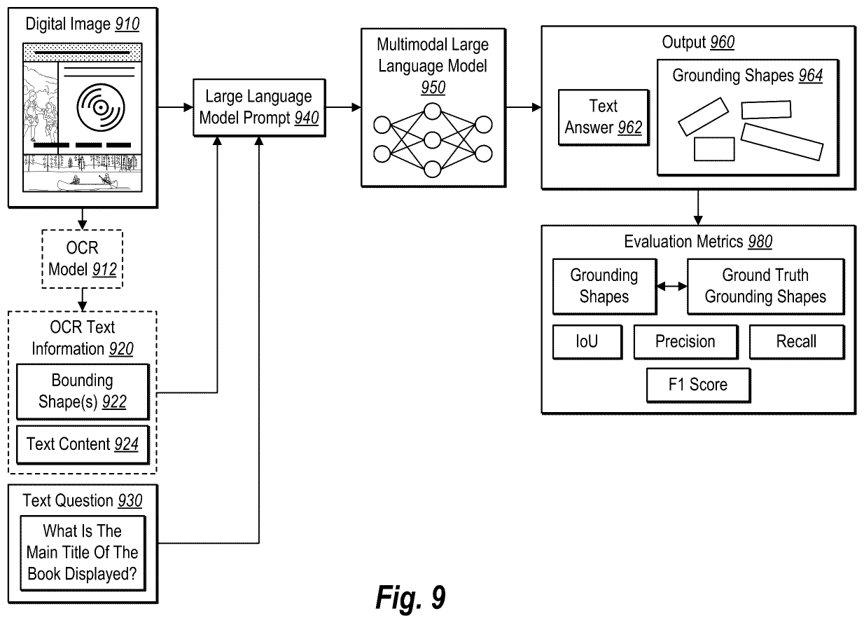

As a comparison, FIG. 9 illustrates an example of the visual text grounding system 106 utilizing the machine learning model dataset to evaluate the OCR-based visual text grounding ability of multimodal large language models in accordance with one or more embodiments.

As shown in FIG. 9, the visual text grounding system 106 evaluates the performance of multimodal large language models in OCR-based visual text grounding. For the OCR-based visual text grounding evaluation, the visual text grounding system 106 utilizes an OCR model 912 to generate OCR text information 920 to facilitate the generation of the grounding shapes 964 by the multimodal large language model 950. As shown, the bounding shape(s) 922 and text content 924 obtained from the OCR model 912 is included in the large language model prompt 940. For the OCR-based visual text grounding evaluation, the grounding shape generation task is converted into a grounding shape selection task, in which the multimodal large language model 950 does not need to generate coordinates from scratch but only needs to select the correct subset of the bounding shape(s) 922 from the large language model prompt 940.

To illustrate, the visual text grounding system 106 evaluates the performance of the multimodal large language model 950 based on the large language model prompt 940 that includes a digital image 910, a text question 930, the bounding shape(s) 922, the text content 924, and an instruction generate an output 960 (e.g., text answer 962 and grounding shapes 964). As shown, the visual text grounding system 106 evaluates the performance of the multimodal large language model 840 when generating the grounding shapes 854 based on the large language model prompt 940. In one or more embodiments, the visual text grounding system 106 utilizes the large language model prompt 940 such as the following:

```
Prompt:
{question }
Please first answer the question according to the given image and
then select the grounded bounding shape that support your answer.
The width of the image is {width}px and the height is {height}px. All
the bounding shape are provided below in the CSS format
textElement-1 { {
} },
  left: {left}px;
  top: {top}px;
  width: {width}px;
  height: {height}px;
  content: “{text}”;
  textElement-2 { {
} },
  left: {left}px;
  top: {top}px;
  width: {width}px;
  height: {height}px;
  content: “{text}”;
} },
....
```

As shown in FIG. 9, the visual text grounding system 106 evaluates the multimodal large language model 950 utilizing evaluation metrics 980 including an IoU score at the instance level, precision, recall, and F1 score. In particular, the visual text grounding system 106 utilizes the Instance-level IoU to measure the overlap between the selected grounded bounding shape and the ground truth bounding shape, normalized by the total number of unique elements. The visual text grounding system 106 utilizes the IoU to evaluate how well the grounding shapes 964 matched the ground truth grounding shapes. The visual text grounding system 106 utilizes the Precision to measure the proportion of correctly selected elements out of all elements selected by the model. Precision reflects the accuracy of the positive predictions. The visual text grounding system 106 utilizes the Recall to measures the proportion of correctly selected elements out of all actual ground truth elements. Recall indicates the ability to capture all relevant elements in the ground truth. The visual text grounding system 106 utilizes the F1 Score to measure the harmonic mean of precision and recall, providing a balanced measure that accounts for both false positives and false negatives.

Table 2 illustrates the results in OCR-based visual text grounding for models trained by existing systems:

TABLE 2
OCR-Based Visual Text Grounding

| Testsets | |
|---|---|
| ChartQA | Doc VQA |

| Metrics (%) | IoU | P | R | F1 | IoU | P | R | F1 |
|---|---|---|---|---|---|---|---|---|
| LLaVA-v1.6-Vicuna-7B | 0.00 | 0.00 | 0.00 | 0.00 | 0.00 | 0.00 | 0.00 | 0.00 |
| DeepSeek-VL-7B-chat | 0.84 | 1.35 | 2.25 | 1.23 | 0.19 | 0.19 | 1.50 | 0.34 |
| Monkey-Chat | 3.58 | 5.38 | 9.91 | 5.05 | 0.94 | 1.19 | 1.75 | 1.15 |
| Phi3-V 2.54 | 3.14 | 5.46 | 3.25 | 0.97 | 1.22 | 2.00 | 1.21 | 0.40 |
| CogVLM2-Llama3-19B | 1.65 | 2.30 | 3.68 | 2.02 | 1.56 | 1.87 | 3.58 | 1.89 |
| MiniCPM-Llama3-V 2.5 | 7.40 | 12.50 | 8.40 | 9.24 | 15.78 | 19.22 | 18.42 | 17.48 |
| VGT (Embedding) | 39.97 | 57.26 | 52.89 | 49.98 | 37.82 | 40.09 | 72.96 | 48.42 |
| VGT (Instruction) | 70.38 | 81.58 | 73.78 | 75.78 | 73.52 | 81.67 | 75.13 | 77.02 |
| GPT-4o | 83.80 | 88.80 | 89.24 | 87.47 | 82.14 | 87.14 | 89.50 | 86.16 |

| | Testsets | | | | | | | | |
|---|---|---|---|---|---|---|---|---|---|
| | Infographics VQA | | | | TRINS | | | | Avg |
| Metrics (%) | IoU | P | R | F1 | IoU | P | R | F1 | Avg |
| LLaVA-v1.6-Vicuna-7B | 0.00 | 0.00 | 0.00 | 0.00 | 0.00 | 0.00 | 0.00 | 0.00 | 0.00 |
| DeepSeek-VL-7B-chat | 0.00 | 0.00 | 0.00 | 0.00 | 1.60 | 1.60 | 2.00 | 1.67 | 0.92 |
| Monkey-Chat | 0.34 | 0.30 | 2.00 | 0.51 | 0.00 | 0.00 | 0.00 | 0.00 | 2.01 |
| Phi3-V | 0.40 | 0.35 | 2.08 | 0.59 | 3.81 | 4.31 | 5.00 | 4.28 | 2.54 |
| CogVLM2-Llama3-19B | 0.42 | 0.84 | 1.75 | 0.71 | 6.76 | 7.93 | 8.33 | 7.53 | 3.30 |
| MiniCPM-Llama3-V 2.5 | 5.71 | 9.87 | 7.34 | 7.14 | 54.06 | 62.06 | 57.89 | 57.95 | 23.15 |
| VGT (Embedding) | 25.58 | 28.68 | 49.14 | 32.93 | 70.01 | 86.38 | 75.94 | 77.32 | 52.84 |
| VGT (Instruction) | 39.23 | 47.29 | 42.86 | 43.90 | 85.48 | 92.17 | 79.94 | 83.62 | 69.77 |
| GPT-4o | 68.19 | 79.57 | 78.81 | 75.82 | 89.08 | 96.06 | 91.53 | 92.16 | 85.34 |

As shown in Table 2, the performance of most models trained by existing methods improves for OCR-based visual text grounding (over OCR-free visual text grounding). However, both the visual text grounding system 106 instruction-based method (e.g., VTG (Instruction)) and the visual text grounding system 106 embedding-based method (e.g., VTG (Embedding)) achieve much better performances compared with the existing systems (although failing to beat the resource-intensive GPT40).

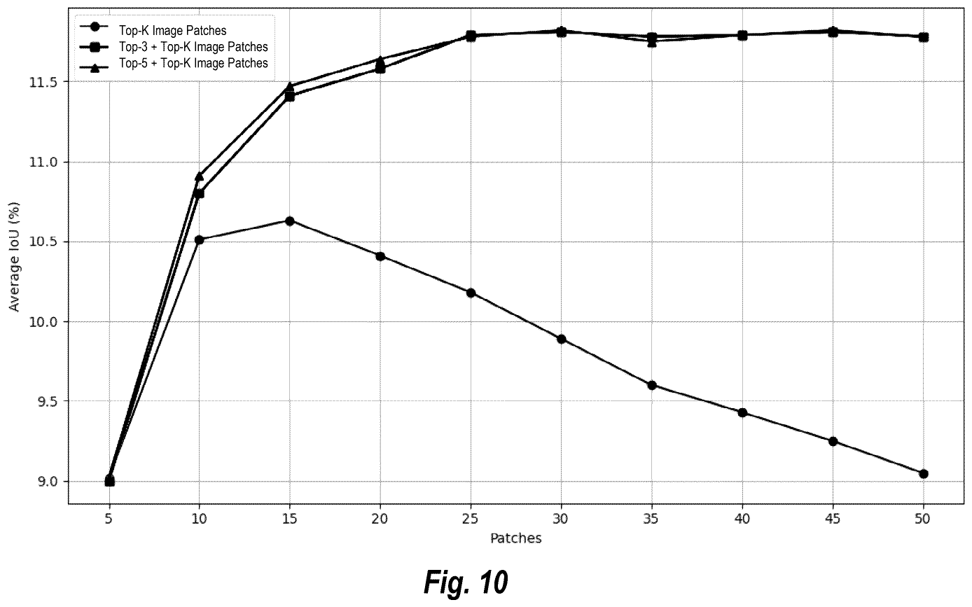

As mentioned, embodiments of the visual text grounding system 106 utilize a multi-level selection of the top-k image patches of the digital image to generate grounding shapes. FIG. 10 illustrates the results of an ablation study of the visual text grounding system 106 utilizing multi-level image patch selection for an OCR-free embedding-based method in accordance with one or more embodiments

As shown in FIG. 10, by utilizing a multi-level selection of the top-k image patches, embodiments of the visual text grounding system 106 demonstrate stable and accurate performance in the OCR-free embedding-based method. In particular, for text answers that correspond to a selection of numerous image patches (e.g., complicated answers), the use of a multi-level selection of the top-k patches by the visual text grounding system 106 provides a marked improvement. This improvement is qualitatively illustrated below in Table 3:

TABLE 3
Ablation studies of the visual text grounding
system 106 OCR-free embedding-based method

| Testsets | Chart | Doc | Info | Trins | Avg |
|---|---|---|---|---|---|
| Metrics (%) | IoU | IoU | IoU | IoU | Avg |
| No Similarity Merging | 8.93 | 9.27 | 6.72 | 14.14 | 9.77 |
| 3 × 3 Similarity Merging | 10.17 | 11.87 | 7.66 | 15.65 | 11.34 |
| 5 × 5 Similarity Merging | 10.01 | 11.32 | 7.32 | 15.14 | 10.95 |
| 7 × 7 Similarity Merging | 9.47 | 10.87 | 6.89 | 14.76 | 10.50 |
| Top-5 Patches | 9.95 | 12.48 | 7.11 | 6.56 | 9.02 |
| Top-10 Patches | 10.37 | 14.10 | 8.16 | 9.42 | 10.51 |
| Top-15 Patches | 9.92 | 13.77 | 7.56 | 11.25 | 10.63 |
| Top-20 Patches | 9.50 | 12.75 | 6.98 | 12.42 | 10.41 |
| Top-25 Patches | 8.95 | 12.05 | 6.50 | 13.22 | 10.18 |
| Top-30 Patches | 8.45 | 11.19 | 6.00 | 13.91 | 9.89 |
| Top-5 + Top-10 Patches | 10.88 | 14.90 | 8.53 | 9.34 | 10.91 |
| Top-5 + Top-15 Patches | 10.96 | 15.38 | 8.40 | 11.13 | 11.47 |
| Top-5 + Top-20 Patches | 10.86 | 15.26 | 8.20 | 12.24 | 11.64 |
| Top-5 + Top-25 Patches | 10.70 | 15.24 | 8.06 | 13.13 | 11.78 |
| Top-5 + Top-30 Patches | 10.51 | 15.02 | 7.85 | 13.88 | 11.82 |

As shown in Table 3, when the visual text grounding system 106 performs a multi-level selection of the top-k patches, the growth of the union is faster than the intersection. As indicated in Table 3, by utilizing a multi-level top-k image patch selection, embodiments of the visual text grounding system 106 reduce the selection of unimportant grounding patches.

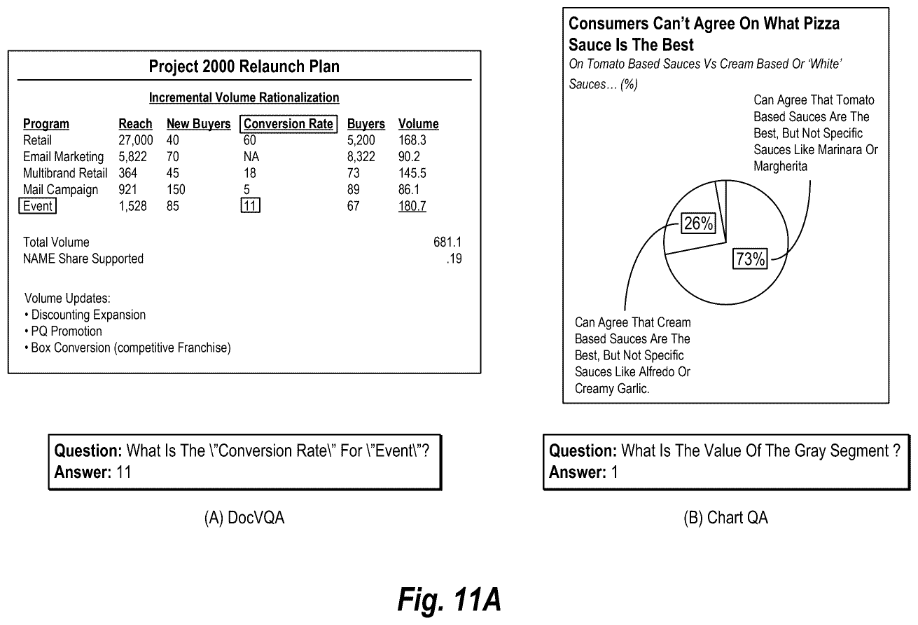

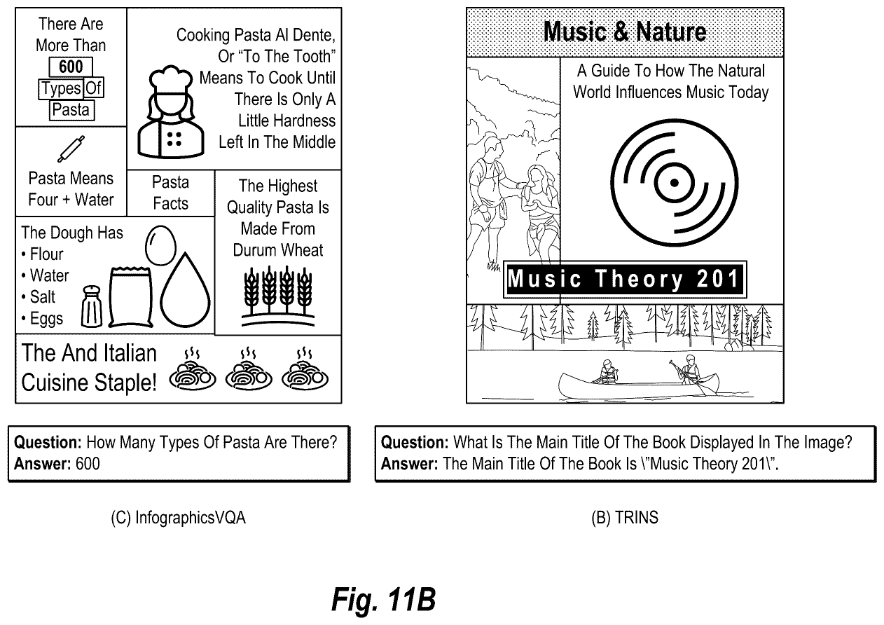

As mentioned, in one or more embodiments, the visual text grounding system 106 generates a machine learning model dataset for training and/or evaluating multimodal large language models in visual text grounding. FIG. 11A-11B illustrate qualitative examples of data instances of a machine learning model dataset generated by the visual text grounding system 106 in accordance with one or more embodiments.

As shown in FIG. 11A, in one or more embodiments, the visual text grounding system 106 generates a machine learning model dataset that includes multimodal digital images generated from sources such as DocVQA. For example, machine learning model dataset includes digital images representing invoices, forms, receipts, reports, letters, and historical documents. As also shown, in certain embodiments, the visual text grounding system 106 generates the machine learning model dataset that includes multimodal digital images generated from sources such as ChartQA. For example, the machine learning model dataset includes digital images such as bar charts, pie charts, line graphs, scatter plots, histograms, and box plots.

As also shown in FIG. 11B, in one or more embodiments, the visual text grounding system 106 generates the machine learning model dataset that includes multimodal digital images generated from sources such as InfographicVQA. For example, the machine learning model dataset includes digital images such as posters, flyers, advertisements, and educational infographics. As also shown, in certain embodiments, the visual text grounding system 106 generates the machine learning model dataset that includes multimodal digital images generated from sources such as TRINS. For example, the machine learning model dataset includes digital images such as posters, book covers, and text-rich images.

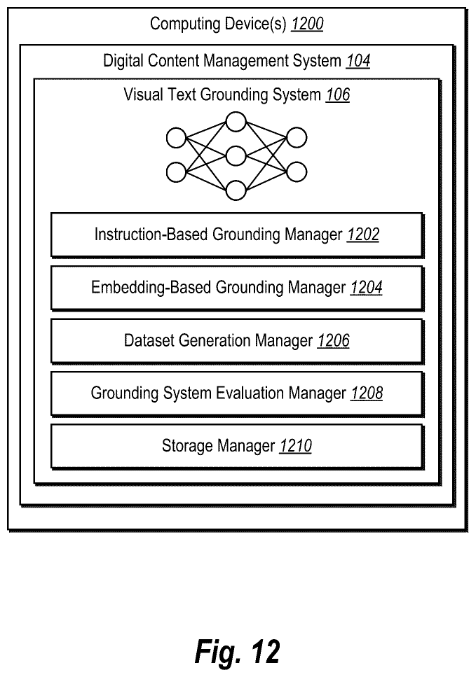

Turning now to FIG. 12, additional detail will now be provided regarding various components and capabilities of the visual text grounding system 106. In particular, FIG. 12 illustrates the visual text grounding system 106 implemented by the computing device 1200 (e.g., the server device(s) 102 and/or one of the client device(s) 110 discussed above with reference to FIG. 1). Additionally, the visual text grounding system 106 is also part of the digital content management system 104. As shown in FIG. 12, the visual text grounding system 106 includes, but is not limited to, an instruction-based grounding manager 1202, an embedding-based grounding manager 1204, a dataset generation manager 1206, a grounding system evaluation manager 1208, and a data storage manager 1210.

As just mentioned, and as illustrated in FIG. 12, the visual text grounding system 106 includes the instruction-based grounding manager 1202. In one or more embodiments, the instruction-based grounding manager 1202 manages training, prompting, and/or evaluating multimodal large language models in visual text grounding system utilizing the instruction-based method to generate grounding content. For example, the instruction-based grounding manager 1202 trains and/or evaluates multimodal large language models by treating the grounding task as an instruction-following task using iterative next token prediction. In some cases, the instruction-based grounding manager 1202 trains, prompts, and/or evaluates multimodal large language based on identifying grounding shapes within the digital image encompassing grounding text supporting a text answer to a text question. In some embodiments, the instruction-based grounding manager 1202 utilizes OCR preprocessing to provide OCR text information to train (and/or evaluates) the multimodal large language models. In some embodiments, the instruction-based grounding manager 1202 trains (and/or evaluates) the multimodal large language models without OCR preprocessing.

As further shown in FIG. 12, the visual text grounding system 106 includes the embedding-based grounding manager 1204 to train and/or evaluate the multimodal large language models. In one or more embodiments, the embedding-based grounding manager 1204 trains (and/or evaluates) the multimodal large language models in visual text grounding by prompting the multimodal large language models to generate image patch embeddings and text token embeddings. For example, the embedding-based grounding manager 1204 compares the image patch embeddings and text token embeddings to select grounding image patches that correspond to the locations of supporting grounding text within digital images. In certain cases, the embedding-based grounding manager 1204 determines grounding text and the grounding shape(s) utilizing the pixels of the selected grounding image patches. In some embodiments, the embedding-based grounding manager 1204 utilizes OCR preprocessing to provide OCR text information to train (and/or evaluate) the multimodal large language models. In some embodiments, the embedding-based grounding manager 1204 trains (and/or evaluate) the multimodal large language models without OCR preprocessing

As also shown in FIG. 12, the visual text grounding system 106 utilizes the dataset generation manager 1206 generate a machine learning model dataset for training and evaluating the performance of multimodal large language models in visual text grounding. In some cases, the dataset generation manager 1206 generates a baseline dataset for training multimodal large language models to identify grounding text within digital images for questions-answer pairs utilizing a dataset generation pipeline. In one or more embodiments, the dataset generation manager 1206 generates a machine learning model dataset utilizing a generation pipeline that includes an OCR processing model, a grounding shape selection model, and a grounding shape assessment model.

In one or more embodiments, the visual text grounding system 106 utilizes a grounding system evaluation manager 1208 to evaluate the performance of multimodal large language models in visual text grounding system 106. In certain embodiments, the grounding system evaluation manager 1208 evaluates multimodal large language models in OCR-free visual text grounding through instructions for generating grounded bounding shape that have never been seen by the multimodal large language models during training (which require a deep reasoning capability to correctly follow). In this way, the grounding system evaluation manager 1208 measures the visual text grounding capability in conjunction with the instruction following capability of the multimodal large language models. In certain embodiments, the grounding system evaluation manager 1208 evaluates the performance of multimodal large language models in OCR-based visual text grounding. For the OCR-based visual text grounding evaluation, the grounding system evaluation manager 1208 converts the grounding shape generation task into a grounding shape selection task, in which the multimodal large language models do not need to generate coordinates from scratch but only needs to select correct grounding shapes from bounding shapes generated by an OCR model.

Additionally, as shown, the visual text grounding system 106 includes the data storage manager 1210. In particular, the data storage manager 1210 (implemented by one or more memory devices) stores digital documents, hierarchical content, non-hierarchical content, document attributes, and document layout penalties. The data storage manager 1210 facilitates the modification and display of digital documents by the visual text grounding system 106.

Each of the components 1200-1210 of the visual text grounding system 106 includes software, hardware, or both. For example, the components 1200-1210 include one or more instructions stored on a computer-readable storage medium and executable by processors of one or more computing devices, such as a client device or server device. When executed by the one or more processors, the computer-executable instructions of the visual text grounding system 106 causes the computing device(s) to perform the methods described herein. Alternatively, the components 1200-1210 include hardware, such as a special-purpose processing device to perform a certain function or group of functions. Alternatively, the components 1200-1210 of the visual text grounding system 106 include a combination of computer-executable instructions and hardware.

Furthermore, the components 1200-1210 of the visual text grounding system 106 are implemented as one or more operating systems, as one or more stand-alone applications, as one or more modules of an application, as one or more plug-ins, as one or more library functions or functions called by other applications, and/or as a cloud-computing model. Thus, in some embodiments, the components 1200-1210 of the visual text grounding system 106 are implemented as a stand-alone application, such as a desktop or mobile application. Furthermore, in some embodiments, the components 1200-1210 of the visual text grounding system 106 are implemented as one or more web-based applications hosted on a remote server. Alternatively, or additionally, the components 1200-1210 of the visual text grounding system 106 are implemented in a suite of mobile device applications or “apps.” For example, in one or more embodiments, the visual text grounding system 106 comprises or operates in connection with digital software applications such as: ADOBE® EXPRESS®, ADOBE® INDESIGN CC, ADOBE® ACROBAT®, and ADOBE® DOCUMENT CLOUD®. The foregoing are either registered trademarks or trademarks of Adobe Inc. in the United States and/or other countries.

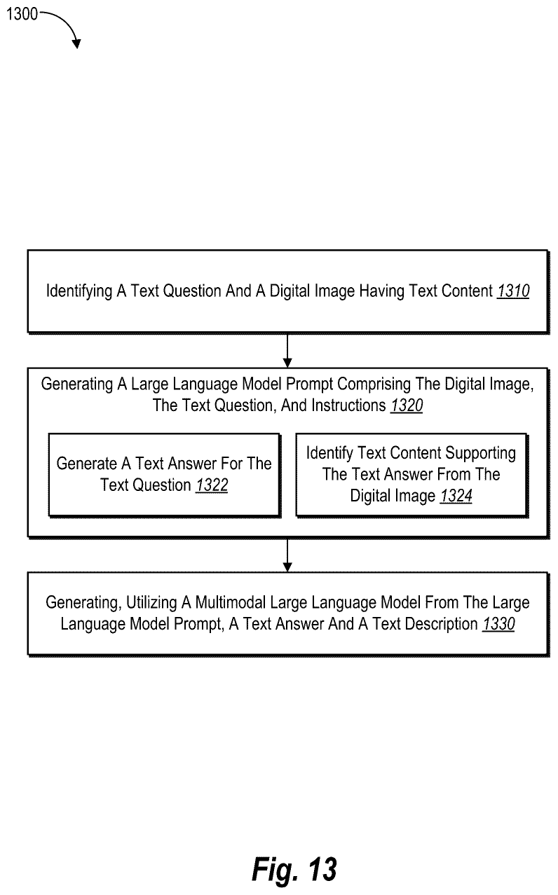

FIGS. 1-10, the corresponding text, and the examples provide a number of different methods, systems, devices, and non-transitory computer-readable media of the visual text grounding system 106. In addition to the foregoing, one or more embodiments are also described in terms of flowcharts comprising acts for accomplishing a particular result, as shown in FIGS. 13-15. In some embodiments, the acts shown in FIGS. 13-15 are performed in connection with more or fewer acts. Further, the acts may be performed in differing orders. Additionally, in various embodiments, the acts described herein are repeated or performed in parallel with one another or parallel with different instances of the same or similar acts. A non-transitory computer-readable medium includes instructions that, when executed by one or more processors, cause a computing device to perform the acts of FIGS. 13-15. In some embodiments, a system is configured to perform the acts of FIGS. 13-15. Alternatively, the acts of FIGS. 13-15 are performed as part of a computer-implemented method. While FIGS. 13-15 illustrate acts according to certain embodiments, alternative embodiments omit, add to, reorder, and/or modify any acts shown in FIGS. 13-15.

FIG. 13 illustrates a flowchart of a series of acts 1300 of the visual text grounding system 106 for identifying text indicating a text answer to a text question from grounding image patches in accordance with one or more embodiments. In certain embodiments, the series of acts 1300 includes an act 1310 of identifying a text question and a digital image having text content. In particular, in one or more embodiments, the act 1310 includes receiving a text question and a digital image having text content. In particular, in certain embodiments, the series of acts 1300 includes an act 1320 of generating a large language model prompt comprising the digital image, the text question, and instructions. In some embodiments, the series of acts includes a sub-act 1322 of generating a large language model prompt comprising instructions to generate a text answer for the text question. In some embodiments, the series of acts includes a sub-act 1324 of generating a large language model prompt comprising instructions to identify text content supporting the text answer from the digital image. In particular, in one or more embodiments, the sub-act 1324 includes generating a large language model prompt comprising instructions to identify a portion of the text content of the digital image supporting the text answer.

In certain embodiments, the series of acts 1300 includes an act 1330 of generating, utilizing a multimodal large language model from the large language model prompt, a text answer and a text description. In particular, in one or more embodiments, the act 1330 includes generating, utilizing a multimodal large language model from the large language model prompt, a text answer to the text question and a text description of a grounding shape within the digital image encompassing grounding text of the text content supporting the text answer.

As illustrated, in some embodiments, the series of acts 1300 also includes generating a large language model prompt by generating, from OCR text information of the digital image, bounding shapes encompassing the text content within the digital image. In some embodiments, the series of acts 1300 includes generating the large language model prompt comprising the digital image, the text question, and the bounding shapes. In particular, in one or more embodiments, the series of acts 1300 includes generating the text description of the grounding shape by, selecting, utilizing the multimodal large language model, one or more of the bounding shapes from the large language model prompt.

Additionally, in one or more embodiments, the series of acts 1300 also includes sequentially generating tokens for an output sequence comprising the text answer and the text description, wherein the tokens are generated based on the digital image, the text question, and previously generated tokens. In one or more embodiments, the series of acts 1300 includes training the multimodal large language model by comparing the text answer and the text description of the grounding shape to a ground truth answer and ground truth text description. In addition (or in the alternative) to the acts described above, in certain embodiments, the visual text grounding system series of acts 1300 also includes generating the text description by generating a location description identifying one or more coordinates in the digital image of the grounding shape encompassing the grounding text.

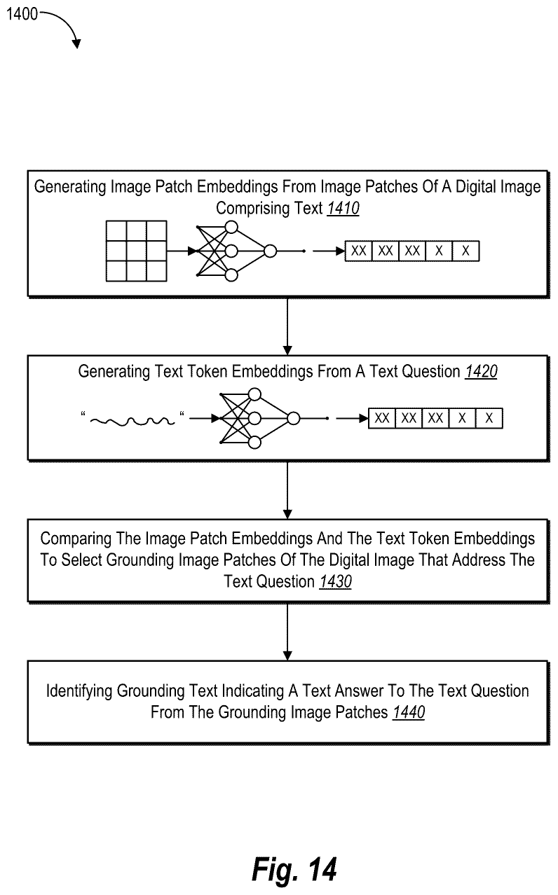

FIG. 14 illustrates an example series of acts 1400 for utilizing a visual text grounding system 106 to generate a text answer to a text question and a corresponding text description of a grounding shape within a digital image. In certain embodiments, the series of acts 1400 includes an act 1410 of generating image patch embeddings from image patches of a digital image comprising text. In particular, in one or more embodiments, the act 1410 includes generating, utilizing one or more multimodal large language models, image patch embeddings from image patches of a digital image comprising text. In certain embodiments, the series of acts 1400 includes an act 1420 of generating text token embeddings from a text question. In particular, in one or more embodiments, the act 1420 includes generating, utilizing the one or more multimodal large language models, text token embeddings from a text question.

In certain embodiments, the series of acts 1400 includes an act 1430 of comparing the image patch embeddings and the text token embeddings to select grounding image patches of the digital image that address the text question. In particular, in one or more embodiments, the act 1430 includes comparing the image patch embeddings of the digital image and the text token embeddings to select one or more grounding image patches of the digital image that address the text question. In certain embodiments, the series of acts 1400 includes an act 1440 of identifying grounding text indicating a text answer to the text question from the grounding image patches. In particular, in one or more embodiments, the act 1440 includes identifying grounding text indicating a text answer to the text question from the one or more grounding image patches.

In some embodiments, the series of acts 1400 also includes generating, utilizing the one or more multimodal large language models, preliminary image patch embeddings from the image patches of the digital image comprising text. Moreover, in one or more embodiments, the visual text grounding system 106 series of acts 1400 includes generating the image patch embeddings by merging the preliminary image patch embeddings with surrounding image patch embeddings. Further still, in some embodiments, the visual text grounding system 106 series of acts 1400 includes generating similarity measures between the image patch embeddings of the digital image and the text token embeddings. Furthermore, in one or more embodiments, the visual text grounding system series of acts 1400 includes selecting a subset of the image patches based on the similarity measures. Moreover, one or more embodiments, the series of acts 1400 includes generating a similarity vector from the similarity measures by combining sets of similarity measures for respective image patches across the text token embeddings. Further still, in one or more embodiments, the series of acts 1400 includes selecting the subset of the image patches based on the similarity vector.

Moreover, in one or more embodiments, the series of acts 1400 includes identifying surrounding image patches to the subset of the image patches in the digital image and similarity measures for the surrounding image patches based on a comparison of the text token embeddings to a set of image patch embeddings for the surrounding image patches. Moreover, one or more embodiments, the series of acts 1400 includes selecting an additional subset of the image patches of the digital image to include in the one or more grounding image patches based on the similarity measures of the surrounding image patches. Furthermore, in one or more embodiments, the series of acts 1400 includes generating a text answer for the text question. Moreover, in one or more embodiments, the series of acts 1400 includes generating, utilizing the one or more multimodal large language models, the text token embeddings from the text question and the text answer.

In one or more embodiments, the series of acts 1400 includes generating a set of mask training embeddings by applying a binary mask to the image patch embeddings based on an overlap of the image patches with a ground truth bounding shape encapsulating ground truth grounding text of the digital image. Further still, in one or more embodiments, the series of acts 1400 includes determining a measure of loss by comparing the set of mask training embeddings and the text token embeddings. In one or more embodiments, the series of acts 1400 further modifying parameters of the one or more multimodal large language models based on the measure of loss.

In addition, in one or more embodiments, the series of acts 1400 includes training the one or more multimodal large language models utilizing a machine learning model dataset generated by generating, from OCR text information of a digital image, a text bounding image by adding bounding shapes encompassing text content within the digital image. Furthermore, in one or more embodiments, the series of acts 1400 includes training the one or more multimodal large language models utilizing a machine learning model dataset generated by selecting a candidate grounding shape from the bounding shapes. In addition, in one or more embodiments, the series of acts 1400 includes training the one or more multimodal large language models utilizing a machine learning model dataset generated by adding the candidate grounding shape to the machine learning model dataset based on a grounding accuracy prediction for the candidate grounding shape.

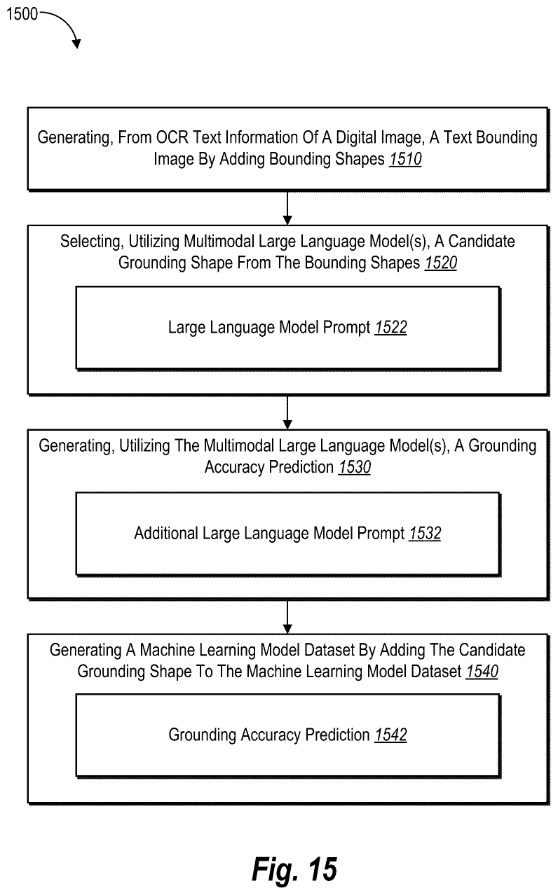

FIG. 15 illustrates a flowchart of a series of acts 1500 of the visual text grounding system 106 for generating a machine learning model dataset in accordance with one or more embodiments. In certain embodiments, the series of acts 1500 includes an act 1510 of generating, from OCR text information of a digital image, a text bounding image by adding bounding shapes. In particular, in one or more embodiments, the act 1510 includes generating, from OCR text information of a digital image, a text bounding image by adding bounding shapes encompassing text content within the digital image. In some embodiments, the series of acts 1500 includes an act 1520 of selecting, utilizing multimodal large language model(s), a candidate grounding shape from the bounding shapes. In some embodiments, the series of acts includes a sub-act 1522 of selecting a candidate grounding shape based on a large language model prompt. In particular, in certain embodiments, the series of acts 1500 includes an act 1520 of selecting, utilizing one or more multimodal large language models, a candidate grounding shape from the bounding shapes based on a large language model prompt comprising the text bounding image and a text question.

In some embodiments, the series of acts 1500 includes an act 1530 of generating, utilizing the multimodal large language model(s), a grounding accuracy prediction. In some embodiments, the series of acts includes a sub-act 1532 of generating the grounding accuracy prediction from an additional large language model prompt. In particular, in certain embodiments, the series of acts 1500 includes an act 1530 of generating, utilizing the one or more multimodal large language models, a grounding accuracy prediction from an additional large language model prompt comprising the candidate grounding shape, the text bounding image, and the text question.

In some embodiments, the series of acts 1500 includes an act 1540 of generating a machine learning model dataset by adding the candidate grounding shape to the machine learning model dataset. In some embodiments, the series of acts includes a sub-act 1542 of generating a machine learning model dataset based on the grounding accuracy prediction. In particular, in certain embodiments, the series of acts 1500 includes an act 1540 of generating a machine learning model dataset for benchmarking or training machine learning models by adding the candidate grounding shape to the machine learning model dataset based on the grounding accuracy prediction.

Moreover, in one or more embodiments, the series of acts 1500 includes selecting, utilizing the one or more multimodal large language models, an additional candidate grounding shape from the bounding shapes based on the large language model prompt comprising the text bounding image and the text question. In one or more embodiments, the series of acts 1500 generating, utilizing the one or more multimodal large language models, an additional grounding accuracy prediction from the additional large language model prompt comprising the candidate grounding shape, the text bounding image, and the text question. Furthermore, in one or more embodiments, the series of acts 1500 includes maintaining, based on the additional grounding accuracy prediction, the machine learning model dataset without adding the additional candidate grounding shape to the machine learning model dataset.

In some embodiments, the series of acts 1500 also includes generating the large language model prompt comprising the text bounding image, the text question, a text answer, the bounding shapes, and the text content. Moreover, in one or more embodiments, the visual text grounding system 106 series of acts 1500 includes assigning index values to the bounding shapes of the text bounding image. Further still, in some embodiments, the visual text grounding system 106 series of acts 1500 includes adding the index values to the text bounding image. Furthermore, in one or more embodiments, the visual text grounding system series of acts 1500 includes generating the large language model prompt comprises generating the large language model prompt comprising the index values assigned to the bounding shapes.

Further still, in one or more embodiments, the series of acts 1500 includes generating the additional large language model prompt comprising the candidate grounding shape, the text bounding image, the text question, a text answer, the bounding shapes, and the text content. Moreover, in one or more embodiments, the series of acts 1500 includes utilizing the machine learning model dataset comprising the candidate grounding shape associated with the text question to evaluate or train a machine learning model.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media. Non-transitory computer-readable storage media (devices) includes optical and/or non-optical memory, disks, or caches that store computer data interpretable by one or more processors to execute particular functions as described herein. A “network” is defined as one or more data links that enable the transport of electronic data between computer systems and/or modules and/or other electronic devices. Information is transferred or provided over a network (either hardwired, wireless, or a combination of hardwired or wireless) to a computer to carry program code in the form of computer-executable instructions or data structures and which can be accessed by a general purpose or special purpose computer.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code.

Embodiments of the present disclosure can also be implemented in cloud computing environments. In this description, “cloud computing” is defined as a model for enabling on-demand network access to a shared pool of configurable computing resources. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth.

FIG. 16 illustrates, in block diagram form, an example computing device 1600 (e.g., the computing device 1600, the client device(s) 110, and/or the server device(s) 102) that may be configured to perform one or more of the processes described above. As shown by FIG. 16, the computing device can comprise a processor(s) 1602, memory 1604, a storage device 1606, I/O devices/interfaces 1608, and a communication interface 1610.

In particular embodiments, processor(s) 1602 includes hardware for executing instructions, such as those making up a computer program. As an example, and not by way of limitation, to execute instructions, processor(s) 1602 may retrieve (or fetch) the instructions from an internal register, an internal cache, memory 1604, or a storage device 1606 and decode and execute them. The computing device 1600 includes memory 1604, which is coupled to the processor(s) 1602. The memory 1604 may be used for storing data, metadata, and programs for execution by the processor(s). The memory 1604 may include one or more of volatile and non-volatile memories. The memory 1604 may be internal or distributed memory. The computing device 1600 includes a storage device 1606 includes storage for storing data or instructions. As an example, and not by way of limitation, storage device 1606 can comprise a non-transitory storage medium described above. The computing device 1600 also includes one or more input or output (“I/O”) devices/interfaces 1608, which are provided to allow a user to provide input to (such as user strokes), receive output from, and otherwise transfer data to and from the computing device 1600. These I/O devices/interfaces 1608 may include a mouse, keypad or a keyboard, a touch screen, camera, optical scanner, network interface, modem, other known I/O devices or a combination of such I/O devices/interfaces 1608.

The computing device 1600 can further include a communication interface 1610. The communication interface 1610 can include hardware, software, or both. The communication interface 1610 can provide one or more interfaces for communication (such as, for example, packet-based communication) between the computing device and one or more other computing devices (e.g., computing device 1600) or one or more networks. The computing device 1600 can further include a bus 1612. The bus 1612 can comprise hardware, software, or both that couples components of computing device 1600 to each other.

What is claimed is:

1. A computer-implemented method comprising:
receiving a text question and a digital image having text content;
generating a large language model prompt comprising the digital image, the text question, and instructions to:
generate a text answer for the text question, and
identify a portion of the text content of the digital image supporting the text answer; and
generating, utilizing a multimodal large language model from the large language model prompt, a text answer to the text question and a text description of a grounding shape within the digital image encompassing grounding text content of the text content supporting the text answer.

2. The computer-implemented method of claim 1, further comprising generating the large language model prompt by:
generating, from OCR text information of the digital image, bounding shapes encompassing the text content within the digital image; and
generating the large language model prompt comprising the digital image, the text question, and the bounding shapes.

3. The computer-implemented method of claim 2, further comprising generating the text description of the grounding shape by, selecting, utilizing the multimodal large language model, one or more of the bounding shapes from the large language model prompt.

4. The computer-implemented method of claim 1, wherein generating the text answer to the text question and the text description comprises sequentially generating tokens for an output sequence comprising the text answer and the text description, wherein the tokens are generated based on the digital image, the text question, and previously generated tokens.

5. The computer-implemented method of claim 1, further comprising training the multimodal large language model by comparing the text answer and the text description of the grounding shape to a ground truth answer and ground truth text description.

6. The computer-implemented method of claim 1, further comprising generating the text description by generating a location description identifying one or more coordinates in the digital image of the grounding shape encompassing the grounding text content.

7. A system comprising:
one or more memory devices; and
one or more processors coupled to the one or more memory devices, the one or more processors configured to cause the system to:
generate, utilizing one or more multimodal large language models, image patch embeddings from image patches of a digital image comprising text;
generate, utilizing the one or more multimodal large language models, text token embeddings from a text question;
compare the image patch embeddings of the digital image and the text token embeddings to select one or more grounding image patches of the digital image that address the text question; and
identify grounding text indicating a text answer to the text question from the one or more grounding image patches.

8. The system of claim 7, wherein the one or more processors are further configured to cause the system to generate the image patch embeddings by:
generating, utilizing the one or more multimodal large language models, preliminary image patch embeddings from the image patches of the digital image; and
generating the image patch embeddings by merging the preliminary image patch embeddings with surrounding image patch embeddings.

9. The system of claim 7, wherein the one or more processors are further configured to cause the system to select the one or more grounding image patches by:
generating similarity measures between the image patch embeddings of the digital image and the text token embeddings; and
selecting a subset of the image patches based on the similarity measures.

10. The system of claim 9, wherein the one or more processors are further configured to cause the system to select the one or more grounding image patches by:
generating a similarity vector from the similarity measures by combining sets of similarity measures for respective image patches across the text token embeddings; and
selecting the subset of the image patches based on the similarity vector.

11. The system of claim 9, wherein the one or more processors are further configured to cause the system to select the one or more grounding image patches by:
identifying surrounding image patches to the subset of the image patches in the digital image and similarity measures for the surrounding image patches based on a comparison of the text token embeddings to a set of image patch embeddings for the surrounding image patches; and
selecting an additional subset of the image patches of the digital image to include in the one or more grounding image patches based on the similarity measures of the surrounding image patches.

12. The system of claim 7, wherein the one or more processors are further configured to cause the system to:
generate a text answer for the text question; and
generate, utilizing the one or more multimodal large language models, the text token embeddings from the text question and the text answer.

13. The system of claim 7, wherein the one or more processors are further configured to cause the system to train the one or more multimodal large language models by:
generating a set of mask training embeddings by applying a binary mask to the image patch embeddings based on an overlap of the image patches with a ground truth grounding shape encapsulating ground truth grounding text of the digital image;
determining a measure of loss by comparing the set of mask training embeddings and the text token embeddings; and
modifying parameters of the one or more multimodal large language models based on the measure of loss.

14. The system of claim 7, wherein the one or more processors are further configured to cause the system to train the one or more multimodal large language models utilizing a machine learning model dataset generated by:
generating, from OCR text information of a digital image, a text bounding image by adding bounding shapes encompassing text content within the digital image;
selecting a candidate grounding shape from the bounding shapes; and
adding the candidate grounding shape to the machine learning model dataset based on a grounding accuracy prediction for the candidate grounding shape.

15. A non-transitory computer readable medium storing executable instructions which, when executed by a processing device, cause the processing device to perform operations comprising:
generating, from OCR text information of a digital image, a text bounding image by adding bounding shapes encompassing text content within the digital image;
selecting, utilizing one or more multimodal large language models, a candidate grounding shape from the bounding shapes based on a large language model prompt comprising the text bounding image and a text question;
generating, utilizing the one or more multimodal large language models, a grounding accuracy prediction from an additional large language model prompt comprising the candidate grounding shape, the text bounding image, and the text question; and
generating a machine learning model dataset for benchmarking or training machine learning models by adding the candidate grounding shape to the machine learning model dataset based on the grounding accuracy prediction.

16. The non-transitory computer readable medium of claim 15, further comprising:
selecting, utilizing the one or more multimodal large language models, an additional candidate grounding shape from the bounding shapes based on the large language model prompt comprising the text bounding image and the text question;
generating, utilizing the one or more multimodal large language models, an additional grounding accuracy prediction from the additional large language model prompt comprising the candidate grounding shape, the text bounding image, and the text question; and
maintaining, based on the additional grounding accuracy prediction, the machine learning model dataset without adding the additional candidate grounding shape to the machine learning model dataset.

17. The non-transitory computer readable medium of claim 15, further comprising generating the large language model prompt comprising the text bounding image, the text question, a text answer, the bounding shapes, and the text content.

18. The non-transitory computer readable medium of claim 17, wherein:
generating the text bounding image comprises:
assigning index values to the bounding shapes of the text bounding image; and
adding the index values to the text bounding image; and
generating the large language model prompt comprises generating the large language model prompt comprising the index values assigned to the bounding shapes.

19. The non-transitory computer readable medium of claim 15, further comprising generating the additional large language model prompt comprising the candidate grounding shape, the text bounding image, the text question, a text answer, the bounding shapes, and the text content.

20. The non-transitory computer readable medium of claim 15, further comprising utilizing the machine learning model dataset comprising the candidate grounding shape associated with the text question to evaluate or train a machine learning model.
